(19) United States
(12) Patent Application Publication
(10) Pub. No.: US 2014/0129681 A1
(43) Pub. Date: May 8, 2014

(54) METHOD OF INSTALLING A DRIVER TO EMULATE A NETWORK CARD

(71) Applicants: Dmitry Alekseevich Gorilovsky, St. Petersburg (RU); Alim Dzhevdetovich Polyakh, St. Petersburg (RU); Anton Leonidovich Tarasenko, St. Petersburg (RU)

(72) Inventors: Dmitry Alekseevich Gorilovsky, St. Petersburg (RU); Alim Dzhevdetovich Polyakh, St. Petersburg (RU); Anton Leonidovich Tarasenko, St. Petersburg (RU)

(21) Appl. No.: 14/125,232

(22) PCT Filed: Jun. 13, 2012
(86) PCT No.: PCT/RU2012/000459

§ 371 Date: Jan. 15, 2014

Related U.S. Application Data
(63) Continuation-in-part of application No. PCT/RU2011/000700, filed on Sep. 13, 2011.
Application No. PCT/RU2011/000700 is a continuation-in-part of application No. PCT/RU2011/000701, filed on Sep. 13, 2011.

(30) Foreign Application Priority Data
Jun. 10, 2011 (GB) 1109758.1
Jul. 20, 2011 (GB) 1112458.3
Jul. 20, 2011 (GB) 1112461.7
Nov. 14, 2011 (GB) 1119623.5

(51) Int. Cl. G06F 9/44; H04L 29/08

(52) U.S. Cl. CPC G06F 9/4411; H04L 67/32
USPC 709/219; 719/327

(57) ABSTRACT

There is provided a method of installing a driver to emulate a network card for communicating between a host and a device, wherein a host operating system class of the host is detected from the device side, comprising the steps of: (i) detecting the host operating system class from the device side by USB enumeration; (ii) attempting to install a first driver to emulate a network card on the host corresponding to the detected host operating system class, wherein the installed first driver is operable to enable communication between the host and the device, and terminating the method if the first driver is successfully installed. The method may further comprise the step of: (iii) If the first driver installation in (ii) is unsuccessful, attempting to install a second driver to emulate a network card on the host corresponding to an operating system class different to the detected host operating system class, wherein the installed second driver is operable to enable communication between the host and the device, and terminating the method if the second driver is successfully installed.

### BACKGROUND OF THE INVENTION

1. Field of the Invention

The field of the invention relates to methods of installing a driver to emulate a network card, such as an Ethernet card, or WWAN device (card), and to related computer program products, systems and devices.

2. Technical Background

When a universal serial bus (USB) device is first connected to a USB host, the USB device enumeration process is started. The enumeration starts by sending a reset signal to the USB device. The data rate of the USB device is determined during the reset signaling. After reset, the USB device's information is read by the host and the device is assigned a unique 7-bit address. If the device is supported by the host, the device drivers needed for communicating with the device are loaded and the device is set to a configured state. If the USB host is restarted, the enumeration process is repeated for all connected devices.

3. Discussion of Related Art

In WO2012/025048A1 and in US2012054372A1, a USB device enumeration process implemented in a USB device is described. The USB device first detects a type of the operating system (OS) of the USB host connected to the device, and performs device enumeration using a process selected from multiple stored processes based on the detected host OS type. To detect the host OS type, the USB device first presents itself to the host as a USB mass storage device (MSD) or human interface device (HID), performs device enumeration to collect OS behavior factors from the host, and determines the OS type from the OS behavior factors. Thereafter, the USB device performs actual device enumeration by presenting itself as the USB device it actually is, using an enumeration process specific to the detected host OS type. The multiple stored enumeration processes are customer configurable. Further, a method is provided to stop an enumeration process when the host is in a Basic Input Output System (BIOS) stage.

However, methods of USB device enumeration may identify a USB host operating system class incorrectly, for example because the USB host may contain an operating system version which was not publicly available when the USB device was sold, or because methods of USB device enumeration may be prone to errors. It is desirable to provide a way of enabling USB communication when USB device enumeration may identify a USB host operating system class incorrectly.

Examples of Communication Protocols are described in the Appendix.

The contents of patent application numbers PCT/RU2012/000026, PCT/RU2012/000228 and of patent application publication numbers WO2012044201(A2), WO2012044202(A2) and WO2012053938(A2) are hereby incorporated by reference.

### SUMMARY OF THE INVENTION

According to a first aspect of the invention, there is provided a method of installing a driver to emulate a network card for communicating between a host and a device, wherein a host operating system class of the host is detected from the device side, comprising the steps of:
(i) detecting the host operating system class from the device side by USB enumeration;
(ii) attempting to install a first driver to emulate a network card on the host corresponding to the detected host operating system class, wherein the installed first driver is operable to enable communication between the host and the device, and terminating the method if the first driver is successfully installed.

The method may be one further comprising the step of:
(iii) If the first driver installation in (ii) is unsuccessful, attempting to install a second driver to emulate a network card on the host corresponding to an operating system class different to the detected host operating system class, wherein the installed second driver is operable to enable communication between the host and the device, and terminating the method if the second driver is successfully installed.

The method may be one wherein a driver to emulate a network card is a driver to emulate a network card over USB protocol, eg. using Ethernet-over-USB protocol, or WWAN.

The method may be one wherein the attempt in (ii) is limited to a predetermined time period, or to a predetermined number of attempts.

The method may be one wherein the attempt in (iii) is limited to a predetermined time period, or to a predetermined number of attempts.

The method may be one wherein the method further comprises the step of:
(iv) Repeating step (iii) once each for each different operating system class in a set of different operating system classes until a successful driver installation occurs, wherein the successfully installed driver is operable to enable communication between the host and the device, and terminating the method if the successfully installed driver is successfully installed.

The method may be one wherein each attempt in (iv) is limited to a corresponding predetermined time period, or to a predetermined number of attempts.

The method may be one wherein the method further comprises the step of:
(iv) Repeating steps (ii) and (iii) for each different operating system class in a set of different operating system classes until a successful driver installation occurs, wherein the successfully installed driver is operable to enable communication between the host and the device, and terminating the method if the successfully installed driver is successfully installed.

The method may be one wherein each attempt in (iv) is limited to a corresponding predetermined time period, or to a predetermined number of attempts.

The method may be one wherein the method further comprises the step of:
(v) If all attempts at driver installation are unsuccessful, prompting a user to connect a physical medium to the host, to install a driver to communicate between the host and the device.

The method may be one wherein the physical medium is a CD-ROM, and connection includes inserting the CD-ROM into a host CD-ROM drive.

The method may be one further comprising the step of driver installation by autorun from the CD-ROM.

The method may be one further comprising the step of driver installation by manual installation from the CD-ROM.

The method may be one wherein the physical medium is a USB-FLASH drive, or hard disk drive, and connection includes connecting the USB-FLASH drive or hard disk drive to the host.

The method may be one wherein a physical medium, eg. CDROM or Flash drive, for driver installation is emulated and mounted automatically.

The method may be one wherein the method further comprises the step of:
(v) If all attempts at driver installation are unsuccessful, prompting a user to connect the host to a server supplying drivers relating to the host operating system, to install a driver to communicate between the host and the device.

The method may be one further comprising the step of: downloading the driver to the host from the server supplying drivers relating to the host operating system, and installing the driver on the host.

The method may be one wherein a detected host operating system class is Windows supporting RNDIS, and an operating system class different to the detected host operating system class is Mac/Linux.

The method may be one wherein a detected host operating system class is Mac/Linux, and an operating system class different to the detected host operating system class is Windows supporting RNDIS.

The method may be one wherein a detected host operating system class is Mac/Linux supporting WWAN, and an operating system class different to the detected host operating system class is Mac/Linux supporting CDC-ECM.

The method may be one wherein a detected host operating system class of step (ii) is Mac/Linux supporting WWAN, an operating system class of step (iii) different to the detected host operating system class is Mac/Linux supporting CDC-ECM, and an operating system class of step (iv) is Windows supporting RNDIS.

The method may be one further comprising the step of terminating the method if installation of a driver to emulate a network card on the host corresponding to the detected host operating system class is unsuccessful.

The method may be one further comprising the step of terminating the method if installation in step (iii) is unsuccessful.

The method may be one further comprising the steps of repeating step (ii) and step (iii) if installation in step (iii) is unsuccessful.

The method may be one further comprising the step of terminating the method if installation in step (iv) is unsuccessful for each different operating system class.

The method may be one further comprising the steps of repeating step (ii), step (iii) and step (iv) if installation in step (iv) is unsuccessful.

The method may be one wherein the set of different operating system classes contains at least three different operating system classes.

The method may be one wherein the driver to emulate a network card for communicating between the host and the device is for wireless communication between the host and the device.

According to a second aspect of the invention, there is provided a system implementing the method of any of the statements according to the first aspect of the invention, the system comprising the host and the device.

The system may be one wherein the device is a mobile communications device.

The system may be one wherein the mobile communications device is operable to provide instant and automatic sharing of a wireless network in response to a single action by a user, the single action comprising a physical contact gesture with the mobile device by the user, or a voice activation command by the user.

The system may be one where the device is a portable router device including a wide area network interface and a local area network interface, the portable router device operable to connect to a wide area network using the wide area network interface, the portable router device further operable to provide a local area network using the local area network interface in response to the device connection with the wide area network satisfying a connection condition.

The system may be one wherein the device is a wireless data enabled USB dongle operable to receive streamed files.

The system may be one wherein the device is a wireless data enabled USB dongle operable to provide internet access.

The system may be one wherein the device is a bar form factor display device comprising front and back major faces, the front major face arranged to present a first display screen and the back major face arranged to present a second display screen different to the first display screen.

The system may be one wherein the device is a display device assembly including a bar form factor display device and a detachable casing, the assembly operable to be assembled wherein the detachable casing is in attachment with the bar form factor display device, the assembly when assembled comprising front and back major faces, wherein the front major face is arranged to present a first display screen which forms part of the bar form factor display device, and wherein the back major face is arranged to present a second display screen different to the first display screen, which forms part of the detachable casing.

According to a third aspect of the invention, there is provided a computer program product operable when installed on a USB device to perform a method of installing a driver to emulate a network card for communicating between a host and the device, wherein a host operating system class of the host is detected from the device side, comprising the steps of:
(i) detecting the host operating system class from the device side by USB enumeration;
(ii) attempting to install a first driver to emulate a network card on the host corresponding to the detected host operating system class, wherein the installed first driver is operable to enable communication between the host and the device, and terminating the method if the first driver is successfully installed.

The computer program product may be further operable to perform the method step of
(iii) If the first driver installation in (ii) is unsuccessful, attempting to install a second driver to emulate a network card on the host corresponding to an operating system class different to the detected host operating system class, wherein the installed second driver is operable to enable communication between the host and the device, and terminating the method if the second driver is successfully installed.

The computer program product may be further operable to perform any of the method steps according to the first aspect of the invention.

### BRIEF DESCRIPTION OF THE DRAWINGS

FIG. 1 shows the front face and back face of an example device in the same Figure. The device is shown in the off state.

FIG. 2 shows the front face and the back face of an example device in the same Figure. The device is shown in the on state.

FIG. 3 shows a side view of an example device. The device may relate to the device of FIG. 2.

FIG. 4 shows the front face and the back face of an example device in the same Figure. The device is shown in the on state. The device may relate to the device of FIG. 2.

FIG. 5 shows a bar form factor device housed inside a detachable case, to form a device assembly.

FIG. 6 is an example of a method of installing a driver to emulate a network card for communicating between a host and a device.

FIG. 7 is an example of a method of installing a driver to emulate a network card for communicating between a host and a device.

FIG. 8 is an example of a method of installing a driver to emulate a network card for communicating between a host and a device.

FIG. 9 is an example of a method of installing a driver to emulate a network card for communicating between a host and a device.

FIG. 10 is an example of a method of installing a driver to emulate a network card for communicating between a host and a device.

FIG. 11 is an example of a method of installing a driver to emulate a network card for communicating between a host and a device.

FIG. 12 is an example of a method of installing a driver to emulate a network card for communicating between a host and a device.

FIG. 13 is an example of a sequence of protocol switching performed by a device, and resulting device activity.

FIG. 14 is an example of a sequence of protocol switching performed by a device, and resulting device activity.

FIG. 15 shows an example of a mobile router device with a wireless WAN connection to a WAN network, in which the mobile router device provides LAN connections to devices on a LAN.

FIG. 16 shows an example of a mobile router device with no wireless WAN connection to a WAN network, in which the mobile router device provides no LAN connections to devices.

FIG. 17 shows an example of a mobile router device with a weak wireless WAN connection to a WAN network, in which the mobile router device provides no LAN connections to devices.

FIG. 18 shows an example of a mobile router device with no wireless WAN connection to a WAN network, in which the mobile router device provides LAN connections to devices on a LAN.

FIG. 19 shows an example of a mobile device which informs its user that no local area network is available at the present time.

FIG. 20 shows an example of a mobile device which informs its user that no local area network is available because a wide area network is not available.

FIG. 21 shows an example of a mobile device which informs its user that no local area network is available because a wide area network signal is too weak.

FIG. 22 shows an example of a mobile router which informs its user that no local area network is provided at the present time.

FIG. 23 shows an example of a mobile router which informs its user that no local area network is provided because a wide area network is not available.

FIG. 24 shows an example of a mobile router which informs its user that no local area network is provided because a wide area network signal is too weak.

### DETAILED DESCRIPTION

Device with Sequence of Protocol Switching

There is provided a device, such as a communications device, such as a mobile communications device. Examples of mobile communications devices include mobile phones, smart phones, tablet computers, and laptop computers with a mobile communications capability, mobile routers and USB dongles. Other communications devices include routers and modems.

To create true plug-and-play experience, we are using in our devices a network card emulating over USB (e.g. Ethernet-over-USB protocol), to emulate generic network (eg. Ethernet-) card or WWAN. Ethernet-over-USB is natively supported in many operating systems such as Linux, UNIX, Mac OS, Windows, Android, mobile OS, tablet OS, iOS etc.

A problem is that different operating systems have different implementations of Ethernet-over-USB protocol. Examples include RNDIS (Microsoft Windows family), CDC (eg. Linux family), and there may be no way to detect host type directly from device side.

### First Example

our device has following sequence of protocol switching:
After power on the device is emulating RNDIS protocol for a limited time (eg. 5 seconds) and waiting for host (eg. PC) response. In case of positive response—the switching sequence stops at this point.
In case of no response from host side, the device starts to emulate CDC protocol
In case of no response for CDC protocol within a limited time period (eg. 5 seconds), the device starts to emulate a mass storage device. The mass storage device may provide drivers for operating systems which do not include the driver pre-installed, eg. outdated operating systems.

In an example of the first example, if the sequence of the first example provides no response from the host side, the sequence is repeated.

### Second Example

our device has following sequence of protocol switching:
After power on the device is emulating a first network protocol over USB (e.g. Ethernet-over-USB protocol or WWAN) (egs. RNDIS (Microsoft Windows family), CDC (eg. Linux family)) for a limited time (eg. 5 seconds, but this may depend on configuration) and waiting for host response. In case of positive response—the switching sequence stops at this point.
In case of no response from host side, the device starts to emulate a second network protocol over USB (e.g. Ethernet-over-USB protocol or WWAN) (egs. RNDIS (Microsoft Windows family), CDC (eg. Linux family)), different to the first network protocol over USB.
In case of no response for the second network protocol over USB (e.g. Ethernet-over-USB) or WWAN within a limited time period (eg. 5 seconds), the device starts to emulate a mass storage device. The mass storage device may provide drivers for operating systems which do not include the driver pre-installed, eg. outdated operating systems.

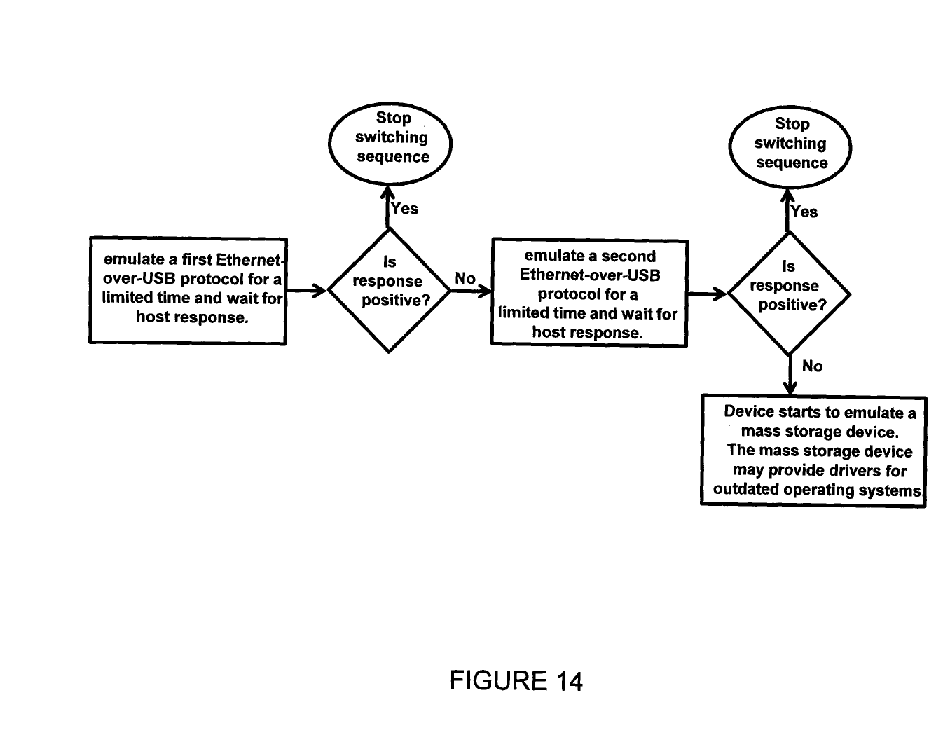

An example is shown in FIG. 14.

In an example of the second example, if the sequence of the second example provides no response from the host side, the sequence is repeated.

### Third Example

our device has following sequence of protocol switching:
After power on the device is emulating RNDIS protocol for a limited time (eg. 5 seconds) and waiting for host (eg. PC) response. In case of positive response—the switching sequence stops at this point.
In case of no response from host side, the device starts to emulate CDC protocol.

In an example of the third example, if the sequence of the third example provides no response from the host side, the sequence is repeated.

### Fourth Example

our device has following sequence of protocol switching:
After power on the device is emulating a first network protocol over USB (e.g. Ethernet-over-USB protocol or WWAN) (egs. RNDIS (Microsoft Windows family), CDC (eg. Linux family)) for a limited time (eg. 5 seconds) and waiting for host response. In case of positive response—the switching sequence stops at this point.
In case of no response from host side, the device starts to emulate a second network protocol over USB (e.g. Ethernet-over-USB protocol or WWAN) (egs. RNDIS (Microsoft Windows family), CDC (eg. Linux family)), different to the first network protocol over USB (e.g. Ethernet-over-USB protocol or WWAN).

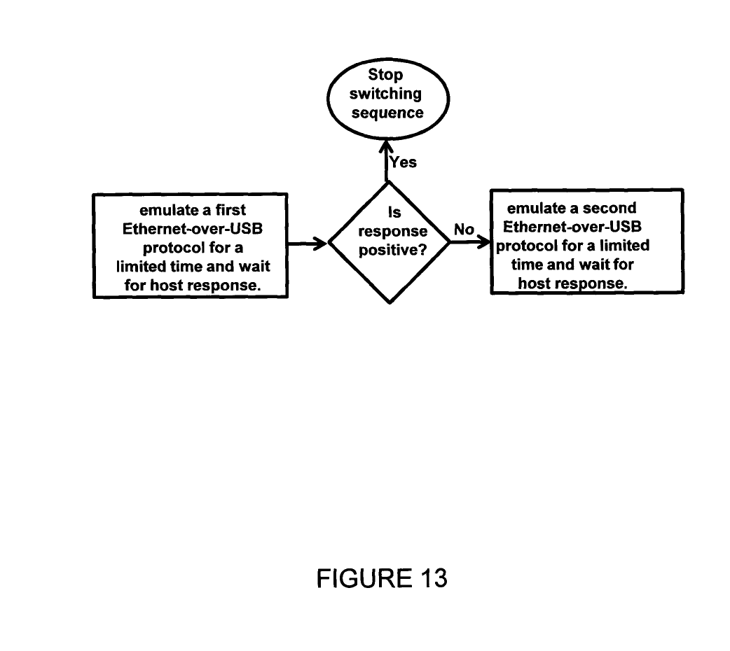

An example is shown in FIG. 13.

In an example of the fourth example, if the sequence of the fourth example provides no response from the host side, the sequence is repeated.

### USB Enumeration Versions

In a further example, the OS is detected. Depending on the OS, USB devices are enumerated differently. As a result, this is used to distinguish OS types between eg. Windows type and Mac OS X/Linux type. However, this method can potentially make a mistake in future versions of OS, so there are specific protection steps in our flow. This method may possibly make a mistake with an existing version of an OS, so there are specific protection steps in our flow.

We can add WWAN (Wireless Wide Area Network) functionality—now it's supported by OS X 10.6, Windows 8 and Linux 2.6.38

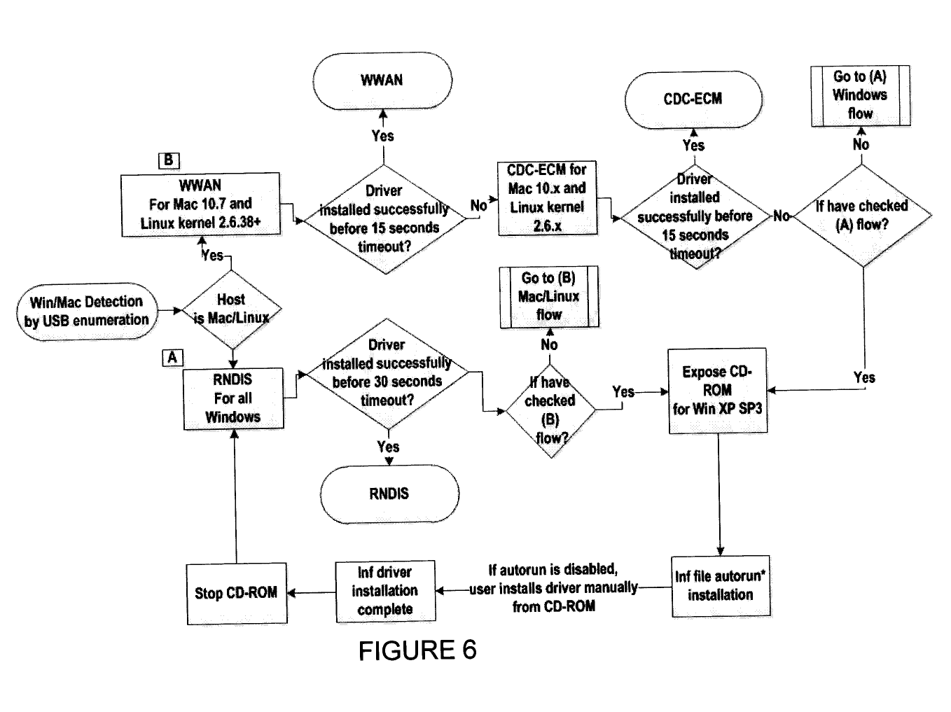

An example of a flow chart in which the OS is detected by USB enumeration is shown in FIG. 6.

We explain our protocol switching flow example of FIG. 6. A difference between the example of FIG. 6 and the first to fourth examples above is the USB enumeration, which we use to detect operation system. Plus, for MAC OS X and Linux specifically, we added WWAN technology support. Mobile broadband technology, also called wireless wide area network (WWAN) technology, provides wireless high-speed Internet access through portable devices.

The first step is to detect OS type by means of USB enumeration. Depending on OS, it enumerates USB devices differently. As a result, this is used to distinguish OS types between Windows type and Mac OS X/Linux type. However, this method can potentially make a mistake in future versions of OS, so there are specific protection steps in our flow. This method may possibly make a mistake with an existing version of an OS, so there are specific protection steps in our flow.

If by means of USB enumeration we observe Mac OS or Linux, we proceed to WWAN for a limited time (eg. 15 seconds). In the case in which WWAN installation was failed, we proceed to CDC-ECM for a limited time (eg. 15 seconds). If CDC-ECM installation failed, we expose RNDIS for a limited time (eg. 30 seconds). In the case in which RNDIS driver installation was failed, we expose CD-ROM (with drivers for Win XP SP3). If autorun is enabled on Win XP SP3 PC, an INF file (driver) is automatically installed. If autorun is disabled, a user installs driver manually from CD-ROM. After driver installation is completed, we stop CD-ROM installation and expose RNDIS.

If by means of USB enumeration we observe Windows PC, we proceed to RNDIS for a limited time (eg. 30 seconds). In the case in which RNDIS driver installation was failed, we expose WWAN for a limited time (e.g. 15 seconds). In the case in which WWAN installation was failed, we proceed to CDC-ECM for a limited time (eg. 15 seconds). In case CDC-ECM installation was failed, we proceed to expose CD-ROM installation. If autorun is enabled on Win XP SP3 PC, an INF file (driver) is automatically installed. If autorun is disabled, a user installs driver manually from CD-ROM. After driver installation is completed, we stop CD-ROM installation and expose RNDIS.

In case of positive response at stage of RNDIS, CDC-ECM or WWAN exposure, the switching sequence stops at this point.

In an example of the method of FIG. 6, after USB enumeration, the attempts to install drivers are tracked. After an unsuccessful attempt has been made to install a driver, no attempt is made to install the same driver again. After installation of all the available drivers has been attempted unsuccessfully, the method terminates.

In an example of the method of FIG. 6, after USB enumeration, the attempts to install drivers are tracked. After an unsuccessful attempt has been made to install a driver, no attempt is made to install the same driver again during that cycle of the flow loop. After installation of all the available drivers has been attempted unsuccessfully, the flow loop performs another cycle.

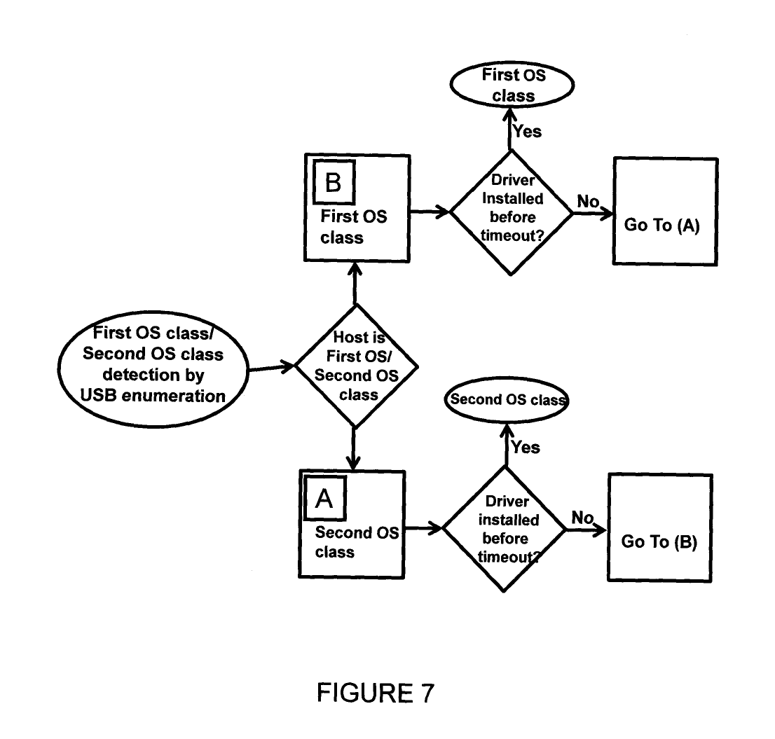

An example of a flow chart in which the OS is detected by USB enumeration is shown in FIG. 7.

The first step is to detect an OS type by means of USB enumeration. Depending on the OS, it enumerates USB devices differently. As a result, this is used to distinguish OS types between a first OS class (eg. Windows type) and a second OS class (eg. Mac OS X/Linux type). However, this method can potentially make a mistake in future versions of OS, so there are specific protection steps in our flow against such a mistake. This method may possibly make a mistake with an existing version of an OS, so there are specific protection steps in our flow.

If the USB enumeration determines that the OS is from a first OS class, the method proceeds to box (B). It is then checked if the host device contains the correct driver to communicate with the USB enabled device. If the check reveals that the host device does not contain the correct driver, an attempt is made to install the correct driver. This step waits for a predetermined time for a result that the correct driver has been successfully installed on the host. If it is determined before the predetermined time passes that the correct driver has been successfully installed on the host, the USB enabled device proceeds to communicate with the host in the context of the first OS class. If it is not determined before the predetermined time passes that the correct driver has been successfully installed on the host, the method passes to box (A).

If the USB enumeration determines that the OS is from a second OS class, the method proceeds to box (A). It is then checked if the host device contains the correct driver to communicate with the USB enabled device. If the check reveals that the host device does not contain the correct driver, an attempt is made to install the correct driver. This step waits for a predetermined time for a result that the correct driver has been successfully installed on the host. If it is determined before the predetermined time passes that the correct driver has been successfully installed on the host, the USB enabled device proceeds to communicate with the host in the context of the second OS class. If it is not determined before the predetermined time passes that the correct driver has been successfully installed on the host, the method passes to box (B).

However, in an example of the method of FIG. 7, after USB enumeration, the attempts to install drivers are tracked. After an unsuccessful attempt has been made to install a driver, no attempt is made to install it again. After installation of all the available drivers has been attempted unsuccessfully, the method terminates.

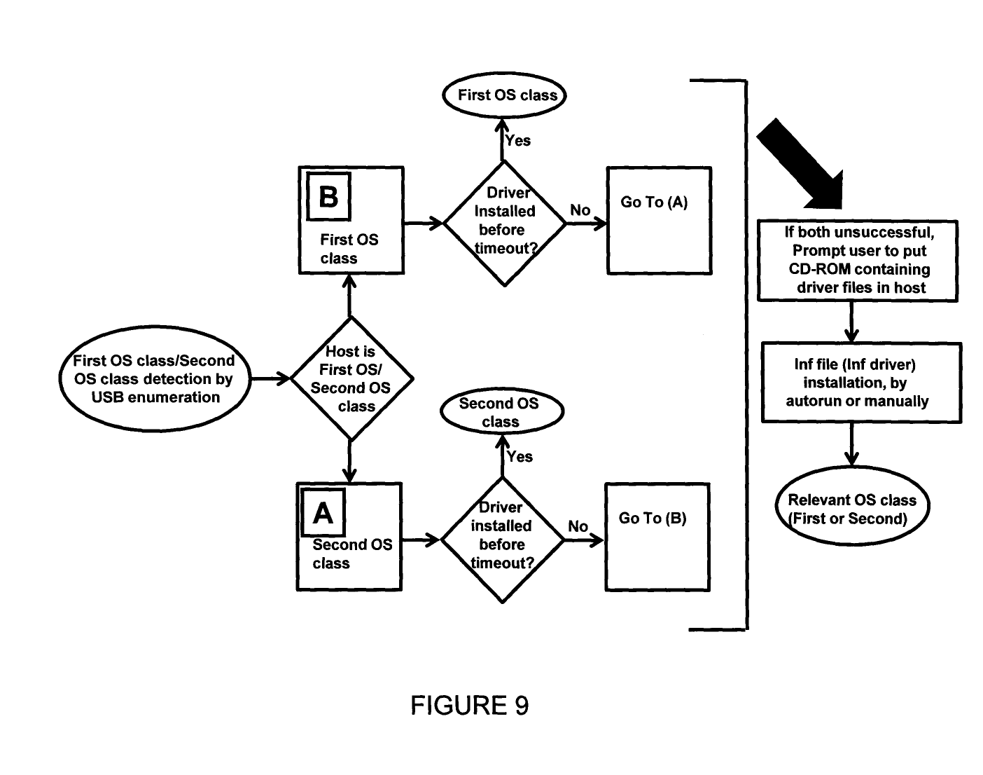

An example of the method of FIG. 7 is shown in FIG. 9. In FIG. 9, after USB enumeration, the attempts to install drivers are tracked. After an unsuccessful attempt has been made to install a driver, no attempt is made to install it again. After installation of all the available drivers has been attempted unsuccessfully, the method prompts a user to connect a physical medium to the host. Connecting a physical medium to the host may include putting a CD-ROM with driver files corresponding to the host OS into the host CD-ROM drive. Connecting a physical medium to the host may include connecting a USB-FLASH drive, an external hard disk drive, or any other external memory with driver files corresponding to the host OS to the host. The INF file (INF driver) or its equivalent is then installed by autorun, or if autorun is not operative, the user installs the INF file (INF driver) or its equivalent manually. The skilled person will understand that in FIG. 9, an objective of the flow is the emulation of CD-ROM installation: ideally the driver will be installed without a user inserting a CD-ROM into the host.

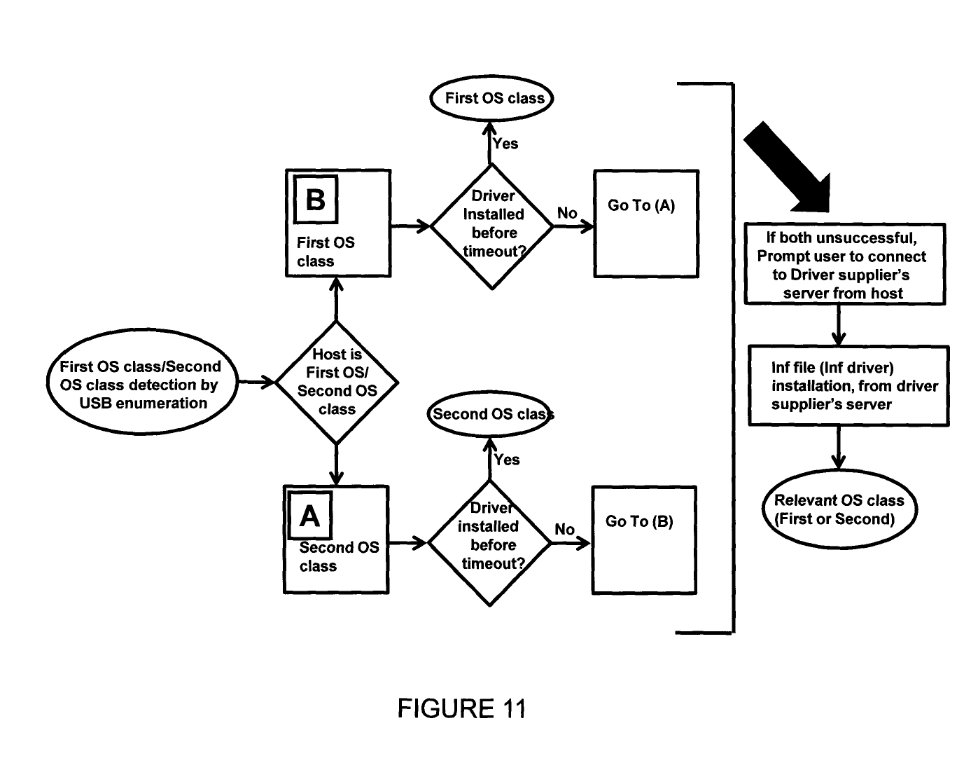

An example of the method of FIG. 7 is shown in FIG. 11. In FIG. 11, after USB enumeration, the attempts to install drivers are tracked. After an unsuccessful attempt has been made to install a driver, no attempt is made to install it again. After installation of all the available drivers has been attempted unsuccessfully, the method prompts a user to connect the host to the OS supplier's server, or to a server which contains the required driver. The INF file (INF driver), or its equivalent, is then installed from the OS supplier's server, or from a server which contains the required driver.

The methods, of which examples are shown in FIGS. 7, 9 and 11, have the advantage that the communications of the USB enabled device are robust against unanticipated changes to future operating systems of the first class or to future operating systems of the second class. For example, if a future operating system of the first class causes it to appear as a result of a USB enumeration test that it is an OS of the second class, the driver corresponding to the second class will not install successfully on the host because the host is really one with an OS of the first class. As a result, the USB enabled device will proceed to try to install a driver of the first OS class, which if successful will enable the USB enabled device to communicate successfully with the host which has an operating system of the first class, even though the USB enumeration test initially identified the operating system class of the host incorrectly.

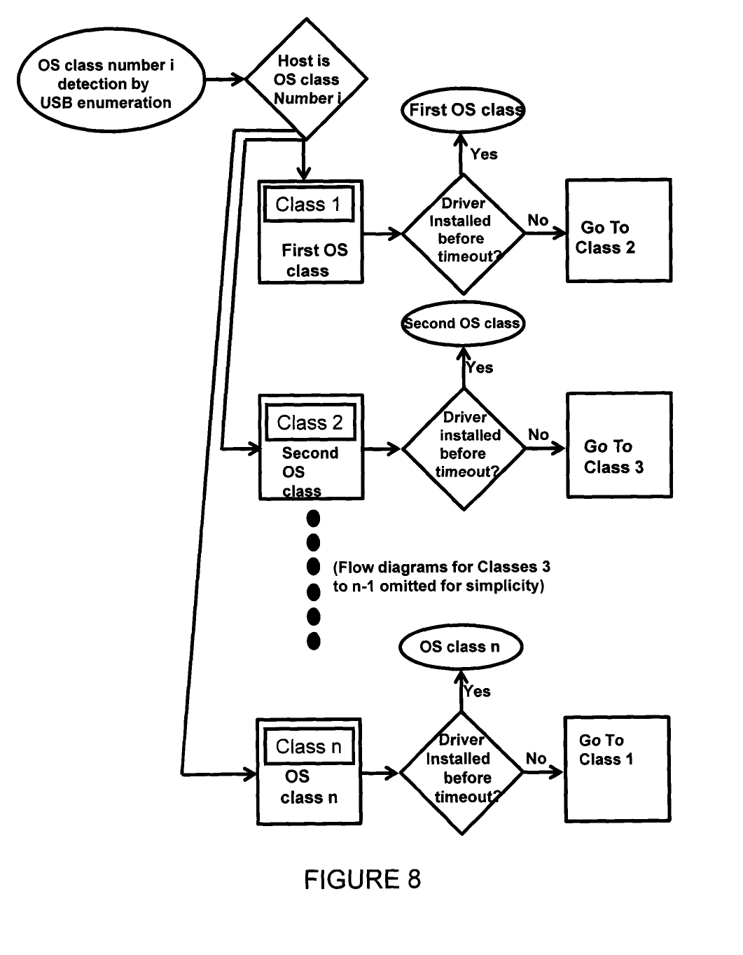

An example of a flow chart in which the OS is detected by USB enumeration is shown in FIG. 8.

The first step is to detect an OS type by means of USB enumeration. Depending on the OS, it enumerates USB devices differently. As a result, this is used to distinguish OS types between n classes of OS, where n is at least 3, including a first OS class (eg. Windows type), a second OS class (eg. Mac OS X/Linux type), and so on. However, this method can potentially make a mistake in future versions of OS, so there are specific protection steps in our flow against such a mistake. This method may possibly make a mistake with an existing version of an OS, so there are specific protection steps in our flow.

If the USB enumeration determines that the OS is from a first OS class, the method proceeds to the Class 1 box. It is then checked if the host device contains the correct driver to communicate with the USB enabled device. If the check reveals that the host device does not contain the correct driver, an attempt is made to install the correct driver. This step waits for a predetermined time for a result that the correct driver has been successfully installed on the host. If it is determined before the predetermined time passes that the correct driver has been successfully installed on the host, the USB enabled device proceeds to communicate with the host in the context of the first OS class. If it is not determined before the predetermined time passes that the correct driver has been successfully installed on the host, the method passes to the Class 2 box.

If the USB enumeration determines that the OS is from a second OS class, the method proceeds to the Class 2 box. It is then checked if the host device contains the correct driver to communicate with the USB enabled device. If the check reveals that the host device does not contain the correct driver, an attempt is made to install the correct driver. This step waits for a predetermined time for a result that the correct driver has been successfully installed on the host. If it is determined before the predetermined time passes that the correct driver has been successfully installed on the host, the USB enabled device proceeds to communicate with the host in the context of the second OS class. If it is not determined before the predetermined time passes that the correct driver has been successfully installed on the host, the method passes to the Class 3 box.

If the USB enumeration determines that the OS is from an i-th OS class, where 1≦i≦n, and n≦3, the method proceeds to the Class i box. It is then checked if the host device contains the correct driver to communicate with the USB enabled device. If the check reveals that the host device does not contain the correct driver, an attempt is made to install the correct driver. This step waits for a predetermined time for a result that the correct driver has been successfully installed on the host. If it is determined before the predetermined time passes that the correct driver has been successfully installed on the host, the USB enabled device proceeds to communicate with the host in the context of the i-th OS class. If it is not determined before the predetermined time passes that the correct driver has been successfully installed on the host, the method passes to the Class [[(i)mod(n)]+1] box. Hence, if i=n, the method passes to the Class 1 box, because (n)mod(n)+1=1.

However, in an example of the method of FIG. 8, after USB enumeration, the attempts to install drivers are tracked. After an unsuccessful attempt has been made to install a driver, no attempt is made to install it again. After installation of all the available drivers has been attempted unsuccessfully, the method terminates.

In a variant of the example of the method of FIG. 8, the attempts to install drivers are tracked. However, repeat attempts to install drivers are allowed. So for example the drivers could be attempted to be installed in the order Class 1-Class 2-Class 1-Class 2-Class 3-Class 1-Class 2-Class 3-Class 4. This could be useful to attempt to install a driver of a more common class more frequently than of a less common class, for example. An attempt to install a driver may be unsuccessful when a host is in a startup phase, for example, so it may be beneficial to attempt more than once to install a driver.

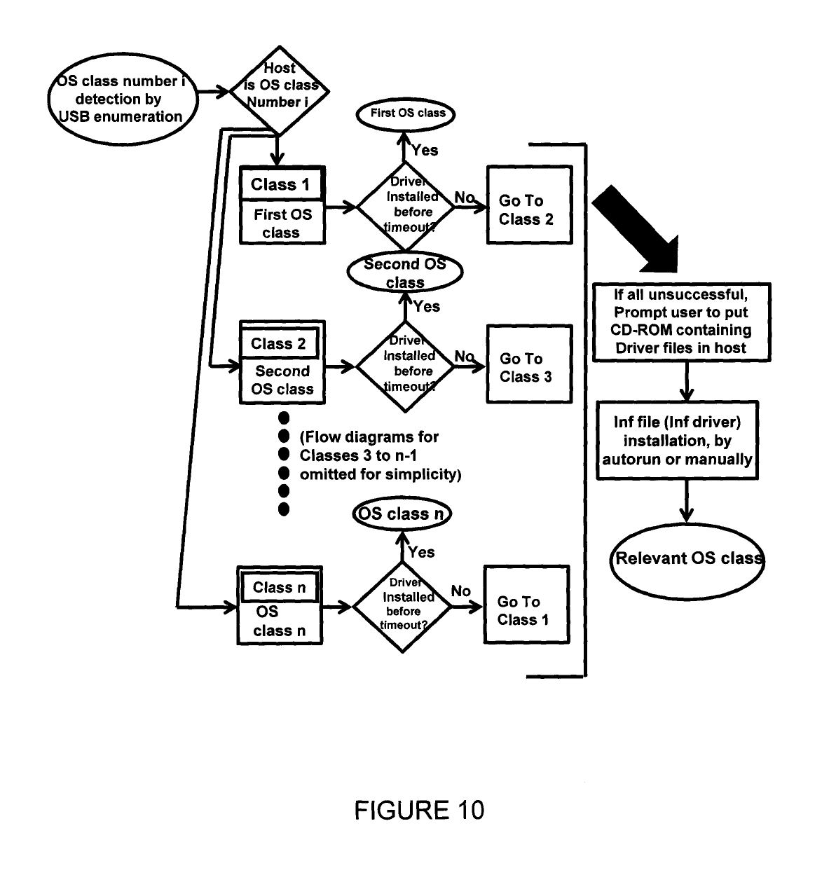

An example of the method of FIG. 8 is shown in FIG. 10. In FIG. 10, after USB enumeration, the attempts to install drivers are tracked. After an unsuccessful attempt has been made to install a driver, no attempt is made to install it again. After installation of all the available drivers has been attempted unsuccessfully, the method prompts a user to connect a physical medium to the host. Connecting a physical medium to the host may include putting a CD-ROM with driver files corresponding to the host OS into the host CD-ROM drive. Connecting a physical medium to the host may include connecting a USB-FLASH drive, an external hard disk drive, or any other external memory with driver files corresponding to the host OS to the host. The INF file (INF driver) or its equivalent is then installed by autorun, or if autorun is not operative, the user installs the INF file (INF driver) or its equivalent manually. The skilled person will understand that in FIG. 10, an objective of the flow is the emulation of CD-ROM installation: ideally the driver will be installed without a user inserting a CD-ROM into the host.

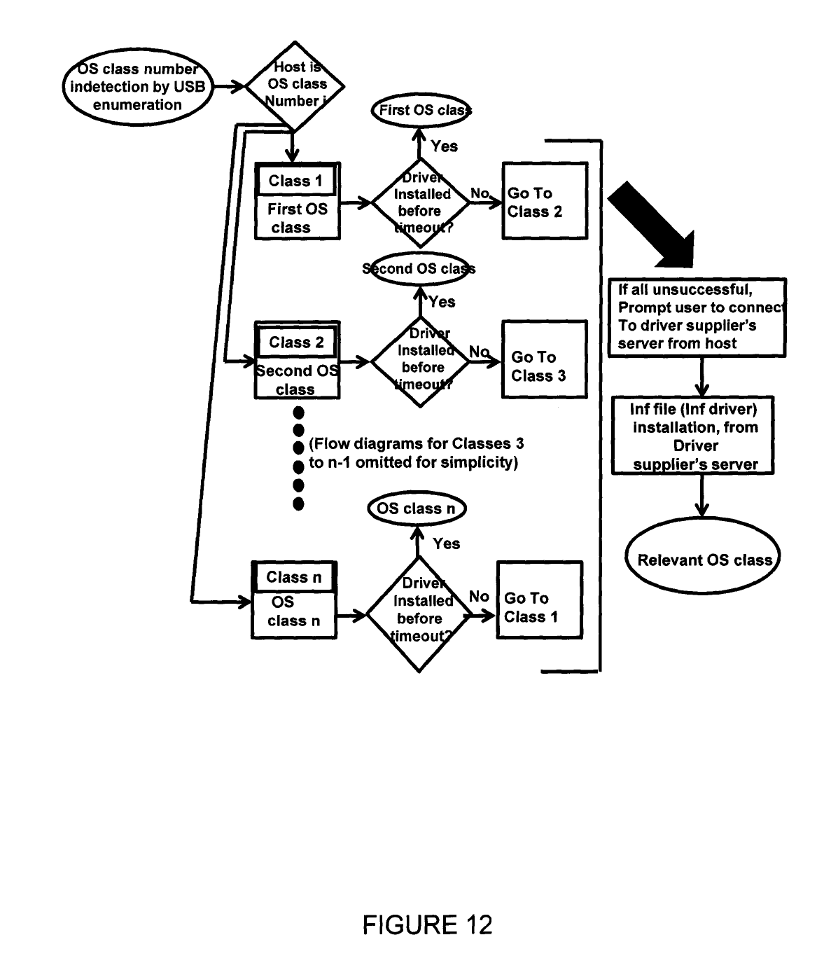

An example of the method of FIG. 8 is shown in FIG. 12. In FIG. 12, after USB enumeration, the attempts to install drivers are tracked. After an unsuccessful attempt has been made to install a driver, no attempt is made to install it again. After installation of all the available drivers has been attempted unsuccessfully, the method prompts a user to connect the host to the driver supplier's server. The INF file (INF driver) or its equivalent is then installed from the driver supplier's server.

The methods, of which examples are shown in FIGS. 8, 10 and 12 have the advantage that the communications of the USB enabled device are robust against unanticipated changes to future operating systems of the relevant class. For example, if a future operating system of the second class causes it to appear as a result of a USB enumeration test that it is an OS of the first class, the driver corresponding to the first class will not install successfully on the host because the host is really one with an OS of the second class. As a result, the USB enabled device will proceed to try to install a driver of the second OS class, which if successful will enable the USB enabled device to communicate successfully with the host which has an operating system of the second class, even though the USB enumeration test initially identified the operating system class of the host incorrectly.

### LAN Connectivity Management (Wi-Fi Interface Management for Portable Devices)

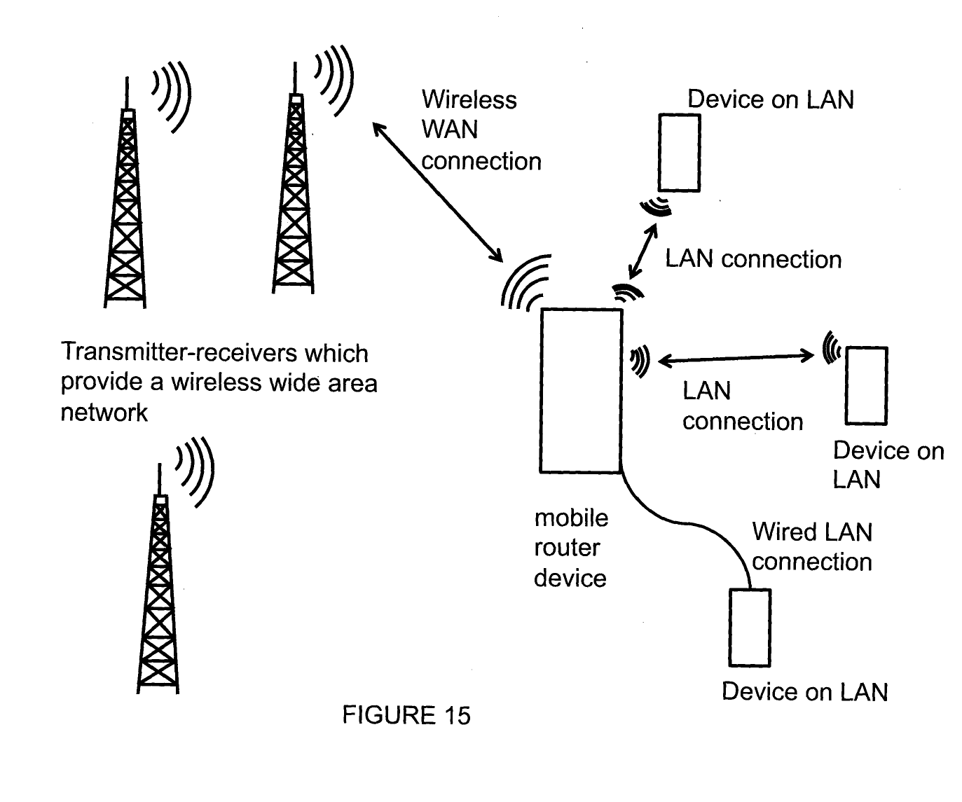

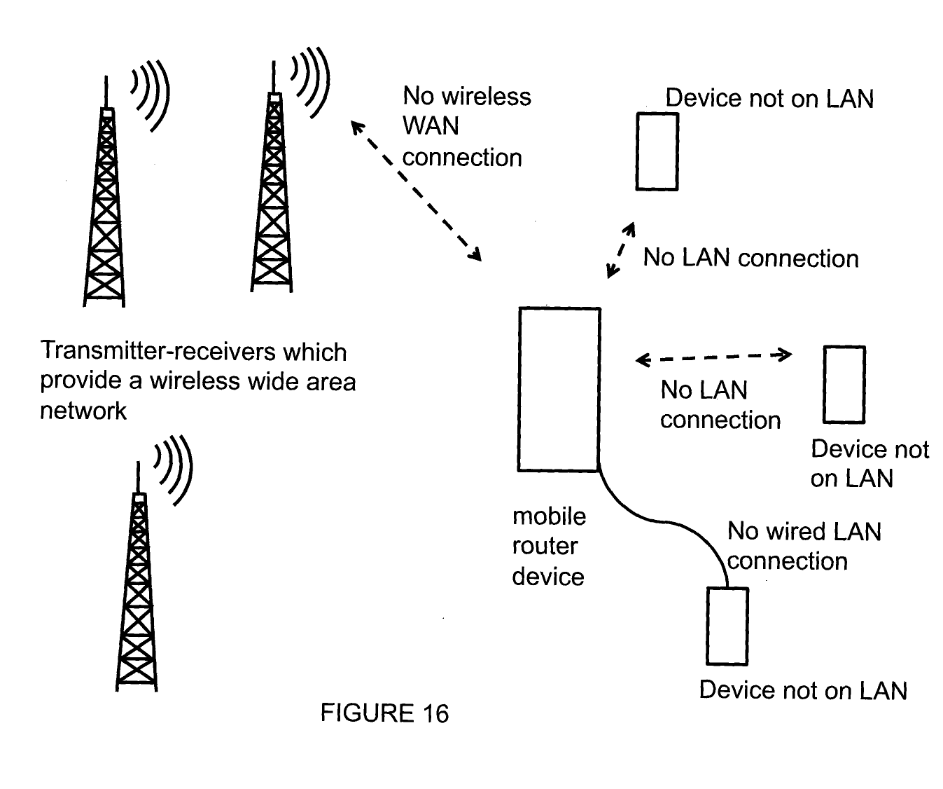

A portable router device is provided with a Wide Area Network (WAN) interface (using for instance standardized telecommunications such as 2G/3G/4G/LTE) and a Local Area Network (LAN) interface (for instance WiFi networks, campus networks, personal networks including Bluetooth and other short range network connectivity). The WAN may be a wireless WAN, as shown for example in FIG. 15. The LAN interface may provide for wireless connectivity, for wired connectivity, or for wired and wireless connectivity, for example as indicated schematically in FIG. 15. The LAN interface may be switched on only when the device has connected to the WAN. For example, in FIG. 16 there is no wireless WAN connection, and the LAN interface of the mobile router device is not operable.

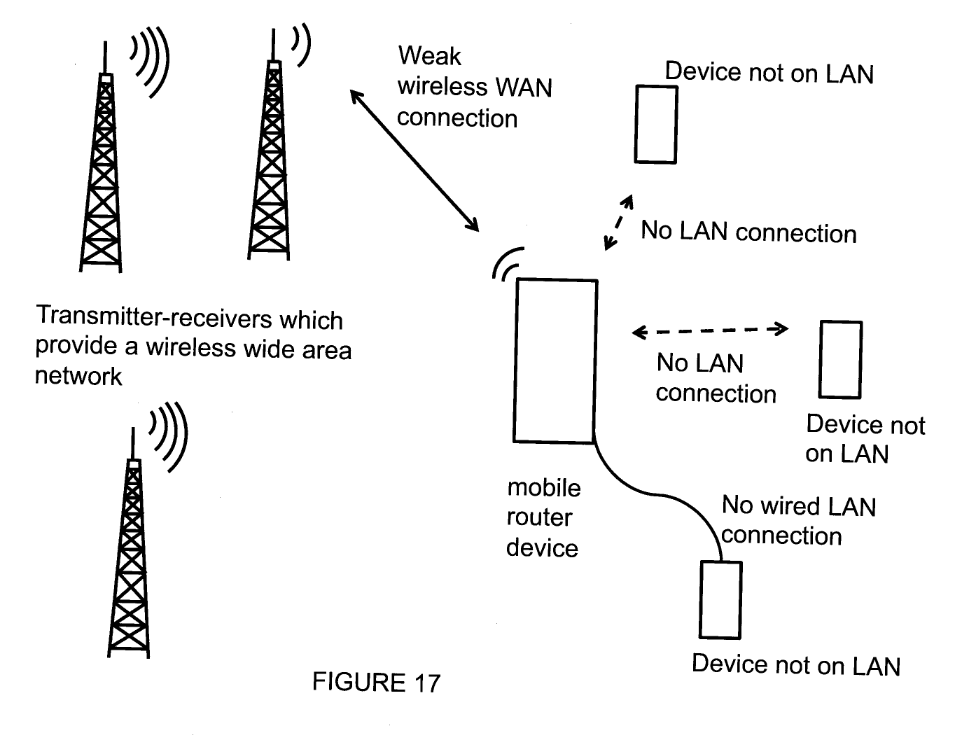

The LAN interface may be switched on only within a predefined range of WAN signal strength. The WAN signal strength may be detected by the portable router device. For example, in FIG. 17 there is only a weak wireless WAN connection, and the LAN interface of the mobile router device is not operable. Other devices are able to connect, through the router, to the WAN network (for example to the internet) via the LAN interface when the LAN interface is activated, as indicated schematically in FIG. 15.

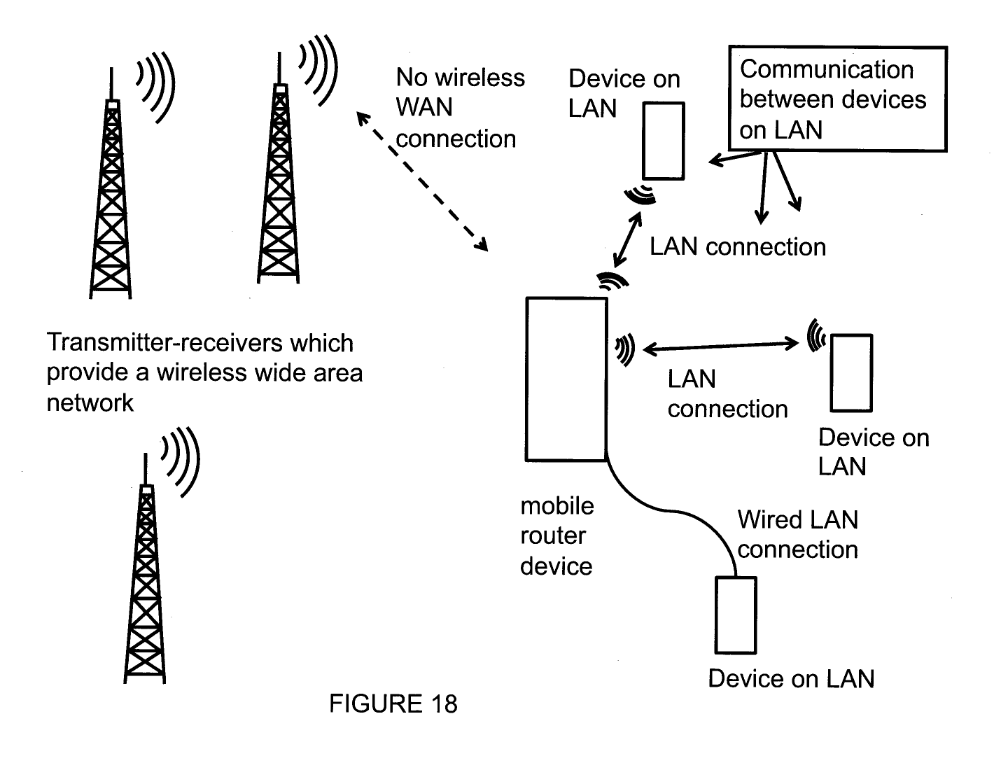

The LAN interface of the router device may be deactivated when the device is not connected to a WAN network. For example, in FIG. 16 there is no wireless WAN connection, and the LAN interface of the mobile router device is not operable. The LAN interface of the router device may be deactivated when the WAN signal strength is below a predefined level. For example, in FIG. 17 there is only a weak wireless WAN connection, and the LAN interface of the mobile router device is not operable. In one example the signal level has to be below the threshold for a certain time before the LAN interface is deactivated. The router device may maintain the LAN activation if for instance there is communication between other devices on the LAN, even when otherwise it would have deactivated the LAN interface because for example there is no connection to a WAN network or the WAN signal strength is below a predefined level. For example, in FIG. 18 there is no wireless WAN connection, but the LAN interface of the mobile router device is operable because there is communication between other devices on the LAN.

The router device reduces power consumption (it is powered for instance with a battery or powered by mains electricity) when the LAN interface is switched off. The router device may include a battery.

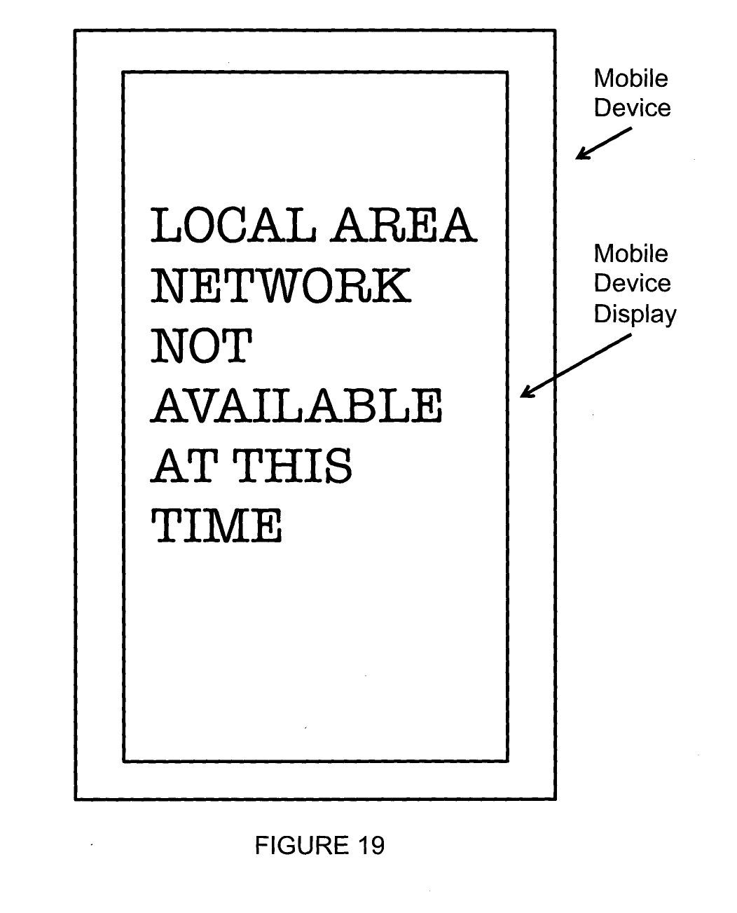

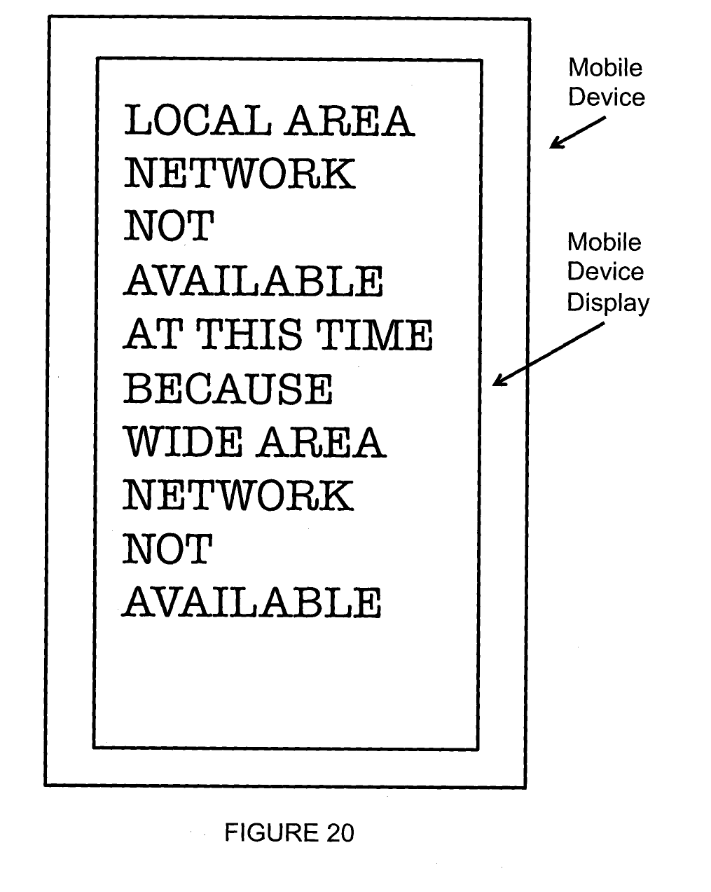

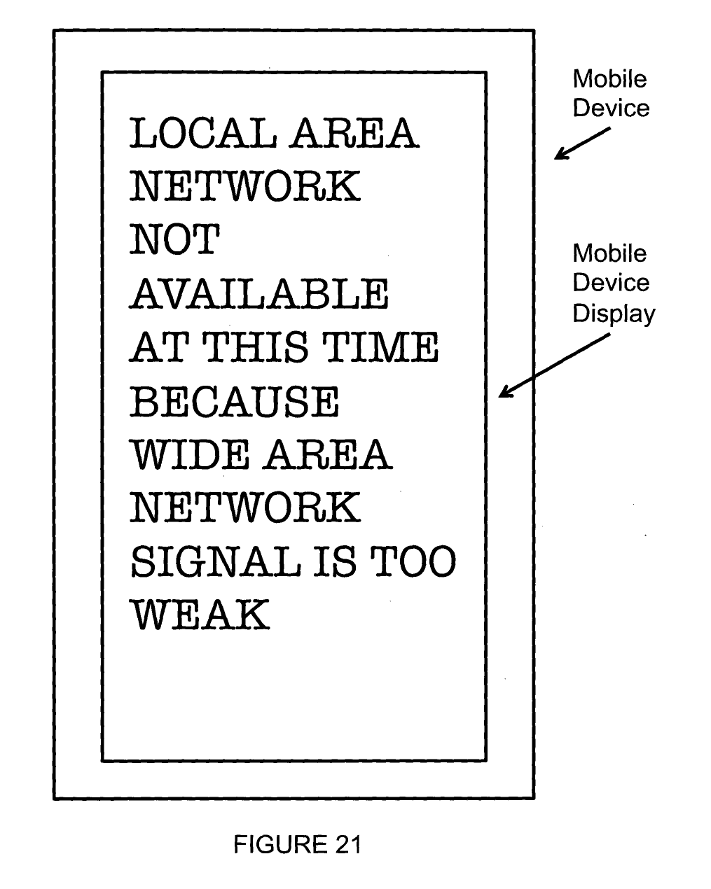

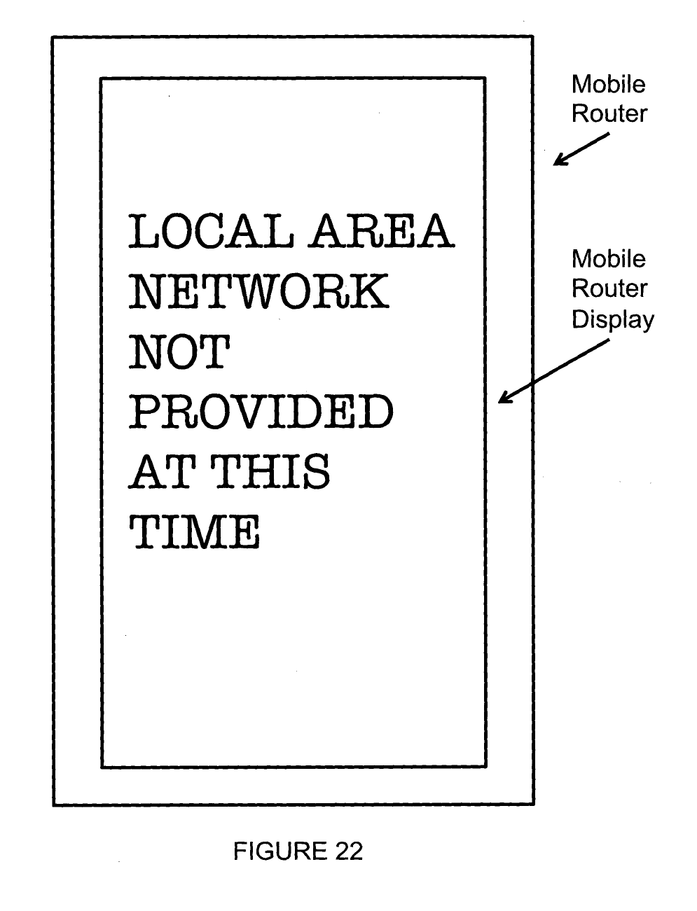

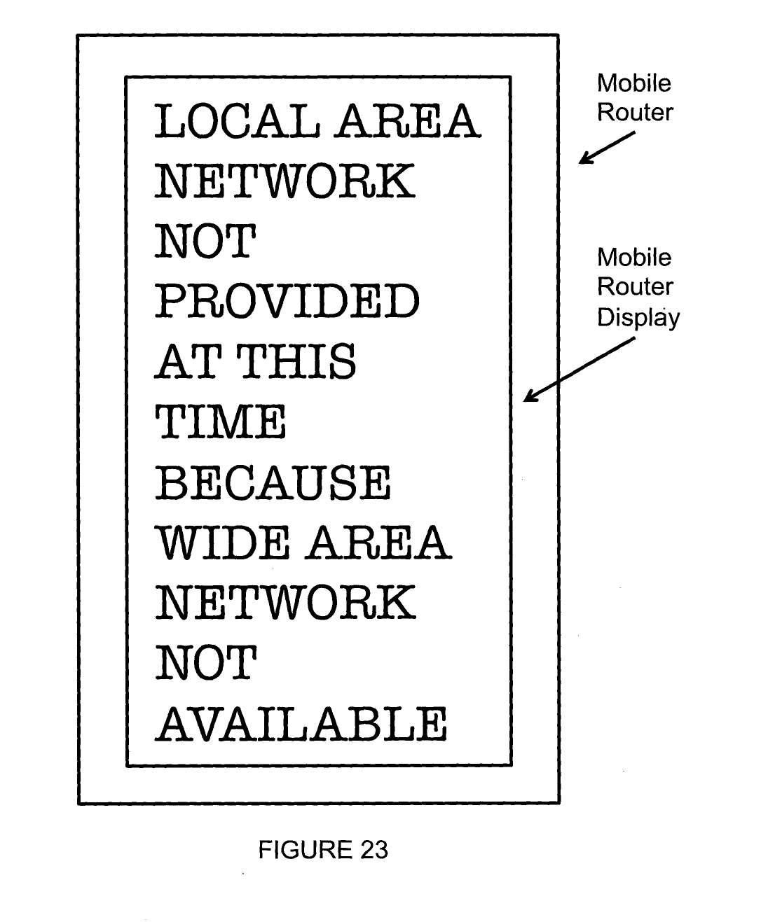

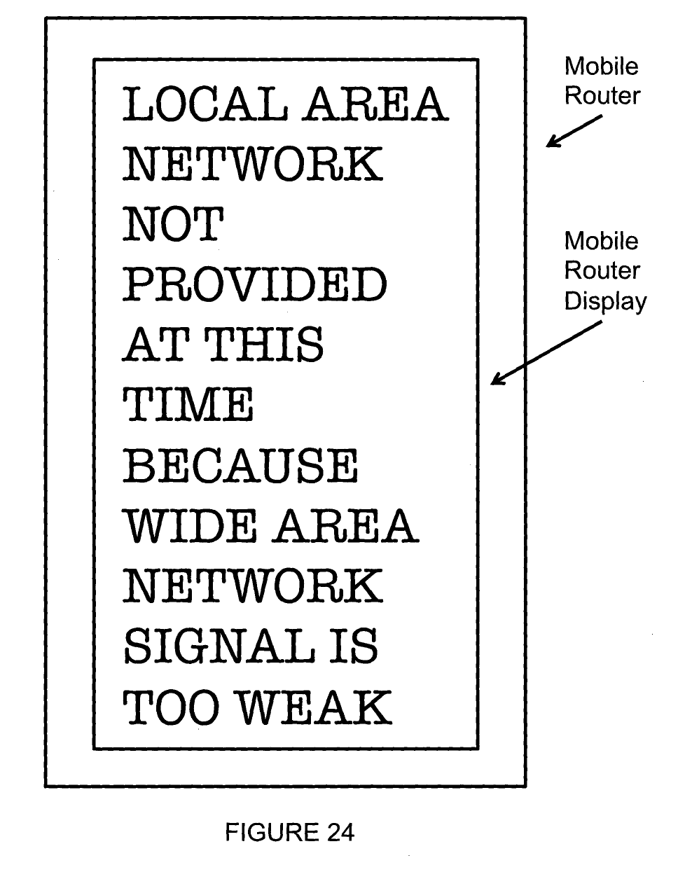

When the WAN connection is absent, or the WAN signal strength is too weak, deactivating the LAN interface will also provide the correct user experience for users of other LAN devices possibly using the router device. For example, this prevents a user of a device connected to the LAN being made to wait some time while his device is unresponsive, when the user would not wait if he knew the WAN connection is absent, or is too weak to provide a reliable service or a service with an acceptably fast data rate. FIG. 19 provides an example of a message provided to a user of a mobile device informing him that a LAN interface is not available. FIG. 20 provides an example of a message provided to a user of a mobile device informing him that a LAN interface is not available because a WAN network is not available. FIG. 21 provides an example of a message provided to a user of a mobile device informing him that a LAN interface is not available because a WAN signal is too weak. FIG. 22 provides an example of a message provided to a user of a mobile router informing him that a LAN interface is not provided. FIG. 23 provides an example of a message provided to a user of a mobile router informing him that a LAN interface is not provided because a WAN network is not available. FIG. 24 provides an example of a message provided to a user of a mobile router informing him that a LAN interface is not provided because a WAN signal is too weak.

The other LAN devices will for instance not try to connect to the internet using the router, if the router is in a low WAN signal strength area (non-serviceable area).

Already existing devices such as portable routers and phones with a portable router function, will provide the option to enable or disable the LAN interface, but not depending on if the device is connected to WAN network or not.

There is provided a portable router device; it has WAN interface (eg. Wireless, eg. 2G/3G/4G) and LAN interface (eg. WiFi). In the case in which we have a WAN (eg. Wireless, eg. 2G, 3G, 4G) signal, the LAN (eg. Wi-Fi) interface is switched on and Wi-Fi devices are able to connect to the WAN through the router. In the case in which we don't have WAN signal, we turn the LAN interface (eg. Wi-Fi) off to save the battery power and to provide the right user experience in Wi-Fi devices such as iPhone: they'll not try to connect to internet through the router in the case in which the router is in a non-serviceable area.

### Mobile Hot Spot—(‘Instant 4G’, for Example)

We provide a simple hard (or soft) switch on a mobile phone (eg. one that is a router), to enable instant and automatic sharing of a WiFi network, using the phone as a mobile hot spot. For example, a user can instantly share internet access using this switch on the phone, instead of a complex user interface (UI). So one use could be at a party to instantly enable friends to access the internet via your phone. Files on the phone could then also be shared (access control would prevent other files from being shared). Alternatively, files on the phone could be shared without providing internet access. A simple hard (or soft) switch on the mobile phone may be provided to disable sharing of a WiFi network.

We provide a simple hard (or soft) switch on a mobile device (eg. one that is a router), to enable instant and automatic sharing of a WiFi network, using the device as a mobile hot spot. For example, a user can instantly share internet access using this switch on the device, instead of a complex user interface (UI). So one use could be at a party to instantly enable friends to access the internet via your mobile device. Files on the mobile device could then also be shared (access control would prevent other files from being shared). The mobile device may be a mobile phone, a mobile smart phone, or a mobile tablet computer device, for example. Alternatively, files on the mobile device could be shared without providing internet access. A simple hard (or soft) switch on the mobile device may be provided to disable sharing of a WiFi network.

We provide a hidden mechanical button on a mobile phone (eg. one that is a router), to enable instant and automatic sharing of a WiFi network, using the phone as a mobile hot spot. For example, a user can instantly share internet access using this hidden mechanical button on the phone, instead of a complex user interface (UI). So one use could be at a party to instantly enable friends to access the internet via your phone. Files on the phone could then also be shared (access control would prevent other files from being shared). Alternatively, files on the phone could be shared without providing internet access. A hidden mechanical button on the mobile phone may be provided to disable sharing of a WiFi network.

We provide a hidden mechanical button on a mobile device (eg. one that is a router), to enable instant and automatic sharing of a WiFi network, using the device as a mobile hot spot. For example, a user can instantly share internet access using this hidden mechanical button on the device, instead of a complex user interface (UI). So one use could be at a party to instantly enable friends to access the internet via your mobile device. Files on the mobile device could then also be shared (access control would prevent other files from being shared). The mobile device may be a mobile phone, a mobile smart phone, or a mobile tablet computer device, for example. Alternatively, files on the mobile device could be shared without providing internet access. A hidden mechanical button on the mobile device may be provided to disable sharing of a WiFi network.

We provide squeeze control on a mobile phone (eg. one that is a router), to enable instant and automatic sharing of a WiFi network, using the phone as a mobile hot spot. For example, a user can instantly share internet access using this squeeze control on the phone, instead of a complex user interface (UI). So one use could be at a party to instantly enable friends to access the internet via your phone. Files on the phone could then also be shared (access control would prevent other files from being shared). Alternatively, files on the phone could be shared without providing internet access. Squeeze control on the mobile phone may be provided to toggle on/off the sharing of a WiFi network.

We provide squeeze control on a mobile device (eg. one that is a router), to enable instant and automatic sharing of a WiFi network, using the device as a mobile hot spot. For example a user can instantly share internet access using this squeeze control on the device, instead of a complex user interface (UI). So one use could be at a party to instantly enable friends to access the internet via your mobile device. Files on the mobile device could then also be shared (access control would prevent other files from being shared). The mobile device may be a mobile phone, a mobile smart phone, or a mobile tablet computer device, for example. Alternatively, files on the mobile device could be shared without providing internet access. Squeeze control on the mobile device may be provided to toggle on/off the sharing of a WiFi network.

We provide capacitor sensor strips in a mobile phone (eg. one that is a router), so that the mobile phone can know if a user has picked it up, such that when a user has picked it up, this enables instant and automatic sharing of a WiFi network, using the phone as a mobile hot spot. For example, a user can instantly share internet access by picking up the phone, instead of a complex user interface (UI). So one use could be at a party to instantly enable friends to access the internet via your phone. Files on the phone could then also be shared (access control would prevent other files from being shared). Alternatively, files on the phone could be shared without providing internet access. Instant and automatic sharing of a WiFi network may be disabled when the user puts the phone down.

We provide capacitor sensor strips in a mobile device (eg. one that is a router), so that the mobile device can know if a user has picked it up, such that when a user has picked it up, this enables instant and automatic sharing of a WiFi network, using the device as a mobile hot spot. For example a user can instantly share internet access by picking up the device, instead of a complex user interface (UI). So one use could be at a party to instantly enable friends to access the internet via your mobile device. Files on the mobile device could then also be shared (access control would prevent other files from being shared). The mobile device may be a mobile phone, a mobile smart phone, or a mobile tablet computer device, for example. Alternatively, files on the mobile device could be shared without providing internet access. Instant and automatic sharing of a WiFi network may be disabled when the user puts the device down.

The mobile phone (eg. one that is a router) may be connected to a 4G mobile phone network. The mobile phone (eg. one that is a router) may be connected to a 3G mobile phone network. The mobile phone (eg. one that is a router) may be connected to a 2G mobile phone network. The mobile device (eg. one that is a router) may be connected to a 4G mobile phone network. The mobile device (eg. one that is a router) may be connected to a 3G mobile phone network. The mobile device (eg. one that is a router) may be connected to a 2G mobile phone network.

The mobile device (eg. one that is a router) (eg. mobile phone) may be a bar form factor device. The device case may be a single block. The device may have a touch screen. The device operating system may be Google Android. The device may have a bistable screen. The device may have a touch screen and a further bistable screen. The bistable screen may be one which can be refreshed wholly or partially, such as for a limited screen area or the whole screen area, starting with any pixel in that screen area. A glass substrate of the device may be curved in conformity with device surface curvature.

The bar form factor display device may comprise a plurality of display screens. Bar form factors include slab, slate, block, bar and candybar. Bar form factor display devices, eg. slate devices such as the iPhone™ and the iPad™, are known. However, these devices comprise only a single display screen. A bar form factor device may be a slate device.

The mobile device (eg. one that is a router) (eg. mobile phone) may be used to define a limited set of users who may connect to the device to enable instant and automatic sharing of a WiFi network with the limited set of users.

The mobile device (eg. one that is a router) (eg. mobile phone) may provide a wireless connection to a personal computer, to enable that computer to connect to the internet.

The mobile device (eg. one that is a router) (eg. mobile phone) may provide a wireless connection to two personal computers, to enable file sharing or resource sharing (eg. sharing of application software) between those two personal computers via a trusted intermediary: the mobile device.

The mobile device (eg. one that is a router) (eg. mobile phone) may provide for file synchronization for files that are shared using automatic sharing of a WiFi network via the mobile device.

The mobile device (eg. one that is a router) may be a personal computer, a video game console, a smartphone, a digital audio player, a mobile phone or a tablet computer, for example. The mobile device may include an integral GPS antenna.

The mobile device (eg. one that is a router) (eg. mobile phone) may provide instant and automatic sharing of a wireless network in response to a single action by a user, the single action comprising a physical contact gesture by the user with the mobile device, or a voice activation command, when the device is already turned on and connected to a mobile phone network. Sharing may be with a device of another user, or with a plurality of other user devices.

### Virtual Web-USB Interface for Wireless Devices

iPhone/iPad has no universal serial bus (USB) connector—a major disadvantage. We provide a WiFi connection from a WiFi dongle with a USB interface; a mobile device (eg. one that is a router) can then interface to a memory in the WiFi dongle, plus any external device that the USB dongle is plugged into, just as though the USB interface was native to the mobile device. So you could view the file structure of files stored on the USB dongle itself in a web browser on the mobile device, or print to a printer the USB dongle is interfaced to, or print to a printer the mobile phone is connected to, for example. The mobile device (eg. one that is a router) (eg. mobile phone) may provide automatic wireless network sharing.

### USB Stick for In-Vehicle Audio

In-vehicle (eg. in-car) audio systems often have USB interfaces for MP3 files, but have no way of accessing internet radio (that is currently only available on really high-end systems). We provide a wireless data enabled USB dongle that can receive streaming radio (e.g. for internet radio stations, Spotify etc.) The wireless data enabled USB dongle may interface wirelessly with a mobile phone or other mobile device (eg. one that is a router). The mobile phone or other mobile device may provide automatic wireless network sharing. The mobile phone or other mobile device may provide wireless access to the internet, thereby providing access via the internet to radio stations that cannot be received by a vehicle radio broadcast receiver. The USB dongle captures a data stream and converts it to a sequence of files—just like the MP3 files the in-vehicle (eg. in-car) audio is designed to read. This enables even a basic in-vehicle (eg. in-car) audio device to have playback/rewind, store etc. functionality for internet radio.

The streamed audio is stored as at least two separate files, which allows the user to choose to skip to the next track using the car audio system software. The user can listen to music online in his vehicle (eg. a car) with no modifications to the in-vehicle (eg. in-car) audio system. An online interface is used for setting up the service, selecting stream source. The online interface may be provided by the mobile phone or other mobile device.

Device with No Visible Mechanical Buttons Example

The mobile device (eg. one that is a router) (eg. mobile phone) may present a seamless, unibody surface—although it can still have hidden mechanical buttons e.g. for volume up, volume down.

### Squeeze Control Example

The mobile device (eg. one that is a router) (eg. mobile phone) may be turned on or off by squeezing it.

### Curved Phone Example

A unique and organic phone shape—essential for rapid product differentiation in a crowded space. The mobile phone (eg. one that is a router) has a concave front face and a convex rear face, which may be of same or similar magnitude of curvature. Concave front may match a path of a finger as wrist rotates. Hence it's very natural to use. Having a curved surface as the vibrating distributed mode loudspeaker (DML) speaker is also better since if the main screen (eg. LCD) with the speaker exciters was instead a flat surface, then it would sound unpleasant if that flat surface is placed down against a tabletop. Curving the surface prevents this happening. Preferred curvature of front and back is cylindrical, rather than spherical or aspherical.

The convex back can have a bistable display. Since the normal resting position is front face down, the back screen with bi-stable display is normally displayed when phone is in the resting position. This resting position is stable. If phone is placed back down (ie convex face down), the phone could spin, which is unstable. Hence a user will likely place phone front face (i.e. concave face) down, with the bi-stable screen showing.

When the phone is in a pocket, the front face (concave face) can face inwards, since this better matches leg curvature. This can be the better configuration (as opposed to front face up) for antenna reception.

### Curved Device Example

A unique and organic device shape—essential for rapid product differentiation in a crowded space. The mobile device has a concave front face and a convex rear face, which may be of same or similar magnitude of curvature. Concave front may match a path of a finger as wrist rotates. Hence it's very natural to use. Having a curved surface as the vibrating DML speaker is also better since if the main screen (eg. LCD) with the speaker exciters was instead a flat surface, then it would sound unpleasant if that flat surface is placed down against a tabletop. Curving the surface prevents this happening. Preferred curvature of front and back is cylindrical, rather than spherical or aspherical.

The convex back can have a bistable display. Since the normal resting position is front face down, the back screen with bi-stable display is normally displayed when device is in the resting position. This resting position is stable. If the device is placed back down (ie convex face down), the device could spin, which is unstable. Hence a user will likely place device front face (i.e. concave face) down, with the bi-stable screen showing.

When the device is in a pocket, the front face (concave face) can face inwards, since this better matches leg curvature. This can be the better configuration (as opposed to front face up) for antenna reception.

The curved device (eg. one that is a router) may be a mobile phone, a mobile smart phone, a mobile tablet computer device, a personal computer, a video game console, or a digital audio player, for example.

### Capacitive ‘Hold’ Sensors Example

With a conventional phone, one has to manually activate the home screen if the phone is in its idle state, usually by pressing a button. We use capacitor sensor strips in the phone, so that the phone can know if the user has picked it up and then automatically wake-up—e.g. activate the start-up/home screen.

This could be used instead of a soft or hard key lock on the phone as well as for the screen brightness.

Regarding Possible Devices and their Possible Detachable Cases

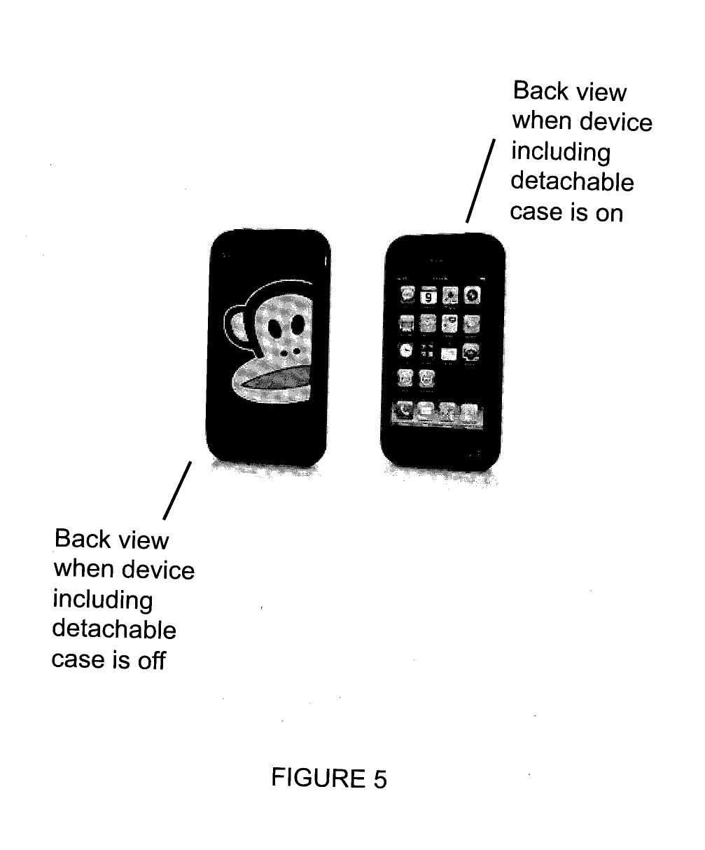

There is provided a detachable device case (eg. phone case) with a bi-stable or low (eg. very low) power consumption display on its back side. FIG. 5 shows a bar form factor device housed inside its detachable case, to form a device assembly. The device (eg. phone) may be provided with a battery. The case may be provided with a battery. If there is a battery inside the device (eg. phone), a charged battery in the case can be used to charge the device battery. A user may detach a detachable case from a device when both the battery in the case and the battery in the device are discharged, in order to attach another detachable case with a well-charged battery, so as to charge the battery of the device, or to power the device. A user may possess several detachable cases, so that the user can exchange detachable cases several times in order to charge the device battery each time, or to power the device, without requiring connection to a mains power source.

A connection (eg. a data connection) from the case to the device (eg. phone) can be implemented by wired connector or wirelessly eg. by Bluetooth. A wired connection between the device and its detachable case may be implemented via a connection between the device and its detachable case, such as via a port of the device, such as by a USB-compatible port of the device, or such as by a custom port of the device. A connection between the device and its detachable case may be implemented via a connection between the device and its detachable case, such as via a port of the device, such as by a custom port of the device. The connection may be wireless. The detachable case may provide a port which is operable to provide the connectivity of the port of the device which is no longer available for use when the device is in connection with its detachable case. Such connectivity may be wired connectivity or wireless connectivity.

A connection (eg. a data connection) between the host and the device (eg. phone) can be implemented by wired connector or wirelessly eg. by Bluetooth. A wired connection between the device and its host may be implemented via a connection between the device and host, such as via a port of the device, such as by a USB-compatible port of the device, or such as by a custom port of the device. A connection between the device and its host may be implemented via a connection between the device and its host, such as via a port of the device, such as by a custom port of the device. The connection may be wireless. The host may provide a port which is operable to provide the connectivity of the port of the device which is no longer available for use when the device is in connection with its host. Such connectivity may be wired connectivity or wireless connectivity.

In an example, the device assembly comprises the device and a detachable case for the device. The device may include external electrical contact elements. The detachable case may include external electrical contact elements. The device and the detachable case may comprise mating guide surfaces which guide the detachable case to the correct position for connection with the device. One of the device and its detachable case may be provided with a magnet, while the other of the device and its detachable case may be provided with a material capable of magnetic attraction, wherein a magnetic force between the magnet and the material capable of magnetic attraction is sufficiently large to pull the detachable module firmly into contact with the device. The contact may include an electrical contact between external electrical contact elements in the detachable module and in the device. In one example, the magnet is in the device. In another example, the magnet is in the detachable case.

User scenarios include those described below.

In an example, there is provided a dual screen bar form factor phone assembly with a bi-stable display. The bi-stable display forms part of a detachable case of the phone assembly. An advantage of a dual screen bar form factor phone assembly is that one screen is always visible, whichever way up the device is placed on a table. By displaying an incoming message on both screens, this ensures that incoming messages are always visible when the device is lying on a table. The first display screen may use electrowetting technology. In another example, the second display screen may use electrowetting technology eg. Liquavista.

The device or the device assembly appearance may be context-related eg. in relation to position such as one determined using a global positioning system (GPS) receiver, or in relation to weather, or in relation to temperature, or in relation to time of day. Context related (eg. position-related) device appearance may include location-based advertising. Context related (eg. position-related) device appearance may include results of a location-based search.

Notification and customization are important tasks in mobile computing. For notification it is known to use sound, vibration or LCD/AMOLED (liquid crystal display/Active-matrix organic light-emitting diode) displays. All those ways provide notification for a limited time and cannot work in always-on mode due to high power consumption. There are cases with segmented bi-stable displays used for notifications, but they don't give right flexibility with notification messages or/and options.

There are many ways for customization of the device or device assembly—pictures and themes for user interface (UI) on main screen, sounds and different accessories like different phone cases can be used to change the look of the device or device assembly. The look of the device or device assembly can be changed by changing what is displayed on the bi-stable screen, such as to give the appearance of a different phone case for example. For example, a device or device assembly skin can be changed. A device assembly skin may be one or more of wallpaper, photos, movies, user-customized content.

In an example, there is provided a bi-stable active matrix and high-resolution display on the back panel of the device or device assembly. The bi-stable display may form part of a detachable case of the device assembly. This improvement gives the following advantages in relation to prior art cases:
Phone customization—user is able to display any pattern, picture or application interface to differentiate their phone from others
Notifications—any application or service is able to display the notification on the back screen. Notification time is not limited, because a bi-stable display is used.
Notifications—any application or service is able to display the notification on the front screen. The notification such as a message may be provided on the front screen and on the back screen.
The information remains on the screen even when the phone itself is switched off. This is important even for manufacturing—a manufacturer can place all needed information directly on the bi-stable screen: eg. serial number, certification logos, country of origin and so on.

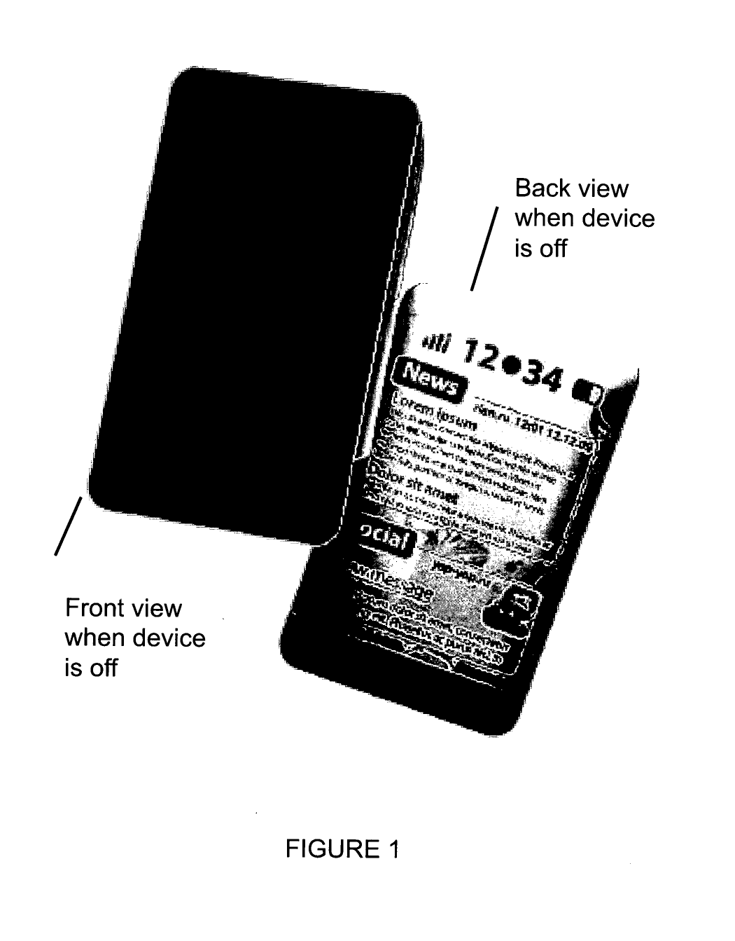

A device may be provided which is similar to the above device assembly, except that where an above device assembly comprises a detachable case, the device does not comprise a case which is normally detachable. An example device is shown in FIG. 1. FIG. 1 shows the front face and back face of an example device in the same Figure.

The device is shown in the off state. In the off state, the front face is not illuminated: it is shown as dark. However, in the off-state, the bi-stable display on the back face continues to display content, which can be viewed as a result of external illumination eg. ambient illumination. In an example of FIG. 1, the front face has an AMOLED display, and the back face has an E-ink bi-stable display.

A bi-stable display may use interferometric modulation technology eg. Qualcomm Mirasol.

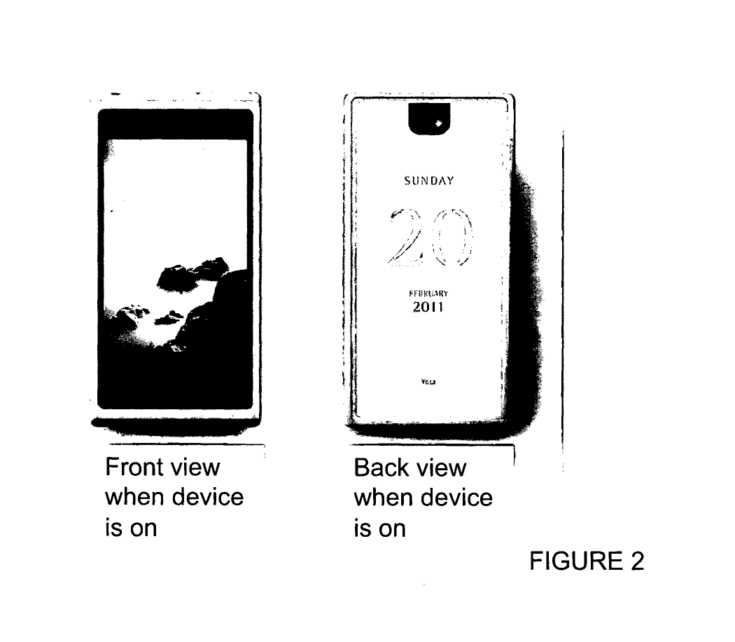

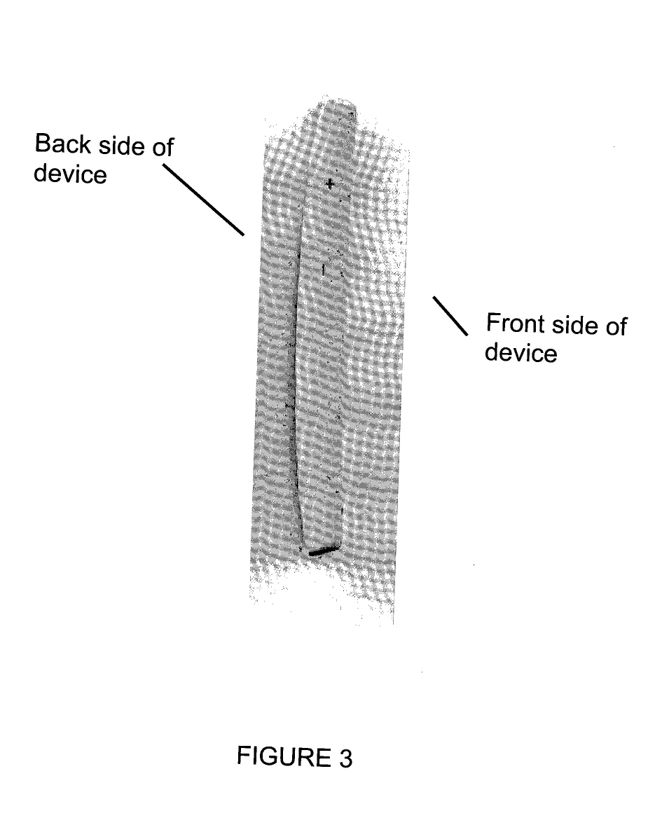

An example is shown in FIG. 2. FIG. 2 shows the front face and the back face of an example device in the same Figure. The device is shown in the on state. In the on state, the front face is illuminated and can display an image or other content. In the on-state, the bi-stable display on the back face also can display an image or other content. In an example of FIG. 2, the front face has an AMOLED display, and the back face has an E-ink bi-stable display. FIG. 3 shows a side view of an example of FIG. 2.

An example is shown in FIG. 3. FIG. 3 shows the front face and the back face of an example device in the same Figure. The device is shown in the on state. In the on state, the front face is illuminated and can display an image or other content. In the on-state, the bi-stable display on the back face also can display an image or other content. In an example of FIG. 3, the front face has an AMOLED display, and the back face has an E-ink bi-stable display.

An example of the front display is: 4″ WVGA (800×480 Or 854×480)
Technology: AMOLED or sIPS/FFS
Nissha Capacitive touch screen

### Glass: Gorilla Glass (Corning)

An example of the back screen is: Electronic Paper Display under glass on back side (E-INK).

Properties of the back face may include:
E-INK Back screen
Sharp Greyscale panel
Perceived as part of case
Low power consumption

Properties of the back screen may include:

### 1. Image

Resolution: 700˜900×480 (possible target: similar to front display)
Colors: 16 Grey scale (E-ink) or 65K (LG)
Contrast: 10:1˜20:1, Reflective ratio: 40%+
Refresh ratio: 150 ms˜400 ms
Ability to refresh any area starting from 1 pixel
Color scheme conforms to case color

### 2. Power Consumption

Approximately 1000 full screen updates using 300 mAh of charge
To minimize power consumption, update rate should be minimized to the order of twice per minute
Does not consume/require power when in bi-stable state

The back screen output may provide:
Interactions,
Control,
Use cases,
Personalization,
Widgets,
Privacy

An example of interactions is text messages from a blog site. An example of control is varying the frequency of back screen updates eg. from once per minute to once per 5 minutes. An example of use cases is receipt of a major emergency notification by an emergency services worker. An example of personalization is putting a photo of a favourite landmark on the back screen. An example of privacy is removing names of companies or individuals from any received incoming message displayed on the back screen.

A bar form factor display device or display device assembly may be one wherein the back display screen output provides a social network screen.

Preinstalled Widgets may include: Clock, Social aggregator, Communications Log, “Favorites” Bucket, News, Weather, Yota Connection, Battery, Contacts Favorites, Latitude & Longitude, and Player.

The Back Screen may provide:
Context related Themes (Weather, Location, Environment)
Widgets, Notifications
Personalization
Post cards
Operator Push (Congratulations, Customer info)

The back display of the device or device assembly may display news provided by a news service. The back display of the device or device assembly may display social messages provided by a social messaging service. The back display of the device or device assembly may display output providing social aggregator output or social network output. The social aggregator output or social network output may be a Facebook page. The back display of the device or device assembly may display a Google search page. The back display of the device or device assembly may display an indication of mobile phone signal strength. The back display of the device or device assembly may display an indication of battery charge state. The back display of the device or device assembly may display calendar information.

The back display of the device or device assembly may be the only operational display of the device or device assembly when the device or device assembly operates in a low power notification mode. When the device or device assembly operates in a low power notification mode the back display of the device or device assembly may be updated in response to an incoming news story provided by a news service. When the device or device assembly operates in a low power notification mode the back display of the device or device assembly may be updated in response to an incoming social message provided by a social messaging service. The device or device assembly may be programmed such that when the device or device assembly operates in a low power notification mode, the back display of the device or device assembly displays content updates of one or more categories, for example, news, social messages, an emergency notification, financial news, earthquake, tsunami or weather. The categories may be preselected, such as by a user or by a network services provider.

### Further Aspects of the Device or Device Assembly

The device or device assembly may be portable. The device or device assembly may be a mobile device or device assembly. The device or device of the device assembly may be a mobile phone, a portable digital assistant, a laptop, a digital audio player or a tablet computer. Known digital audio players include the ipod and mp3 players. Known tablet computers include the ipad. The device or device assembly may include a virtual keyboard. The device or device assembly may have a touch screen. The device or device assembly may have two screens each of which is a touch screen. The bi-stable screen may be a touch screen. A screen that is not a bi-stable screen may be a touch screen. The device or device assembly may include a second bi-stable screen. The device or device assembly may include a second bi-stable screen which is a touch screen. The device or device assembly may include a second bi-stable screen which is not a touch screen.

The bi-stable screen may occupy greater than 50% of the area of the major face of the device or device assembly on which it is located. The bi-stable screen may occupy greater than 60% of the area of the major face of the device or device assembly on which it is located. The bi-stable screen may occupy greater than 70% of the area of the major face of the device or device assembly on which it is located. The bi-stable screen may occupy greater than 80% of the area of the major face of the device or device assembly on which it is located. The bi-stable screen may occupy greater than 90% of the area of the major face of the device or device assembly on which it is located. The bi-stable screen may occupy greater than 95% of the area of the major face of the device or device assembly on which it is located.

The screen other than the bi-stable screen may occupy greater than 50% of the area of the major face of the device or device assembly on which it is located. The screen other than the bi-stable screen may occupy greater than 60% of the area of the major face of the device or device assembly on which it is located. The screen other than the bi-stable screen may occupy greater than 70% of the area of the major face of the device or device assembly on which it is located. The screen other than the bi-stable screen may occupy greater than 80% of the area of the major face of the device or device assembly on which it is located. The screen other than the bi-stable screen may occupy greater than 90% of the area of the major face of the device or device assembly on which it is located. The screen other than the bi-stable screen may occupy greater than 95% of the area of the major face of the device or device assembly on which it is located.

A second bi-stable screen may occupy greater than 50% of the area of the major face of the device or device assembly on which it is located. A second bi-stable screen may occupy greater than 60% of the area of the major face of the device or device assembly on which it is located. A second bi-stable screen may occupy greater than 70% of the area of the major face of the device or device assembly on which it is located. A second bi-stable screen may occupy greater than 80% of the area of the major face of the device or device assembly on which it is located. A second bi-stable screen may occupy greater than 90% of the area of the major face of the device or device assembly on which it is located. A second bi-stable screen may occupy greater than 95% of the area of the major face of the device or device assembly on which it is located.

The device or device assembly may comprise a single backlight module situated between its two major faces. The backlight module may illuminate one display on one major face. The backlight module may illuminate two displays each of which is situated on a different major face of the device or device assembly to the other display.

The device or device assembly including its detachable casing may comprise two backlight modules, each of which may illuminate a display situated on a major face of the device or device assembly including its detachable casing. Each backlight module may illuminate a respective display on a respective major face of the device or device assembly including its detachable casing. The two backlight modules may be situated between two displays of the device or device assembly including its detachable casing, where each display is situated on a different major face of the device or device assembly (including its detachable casing) to the other display. The detachable casing may include a backlight module for illuminating a display of the detachable casing.

The device or device assembly including its detachable casing may have flat (i.e. non-curved) front and back major faces. The device or device assembly including its detachable casing may have one major face that is curved with the other major face being flat (i.e. non-curved).

Curved Bar Form Factor Display Device Assembly (Eg. Phone) Including Detachable Casing

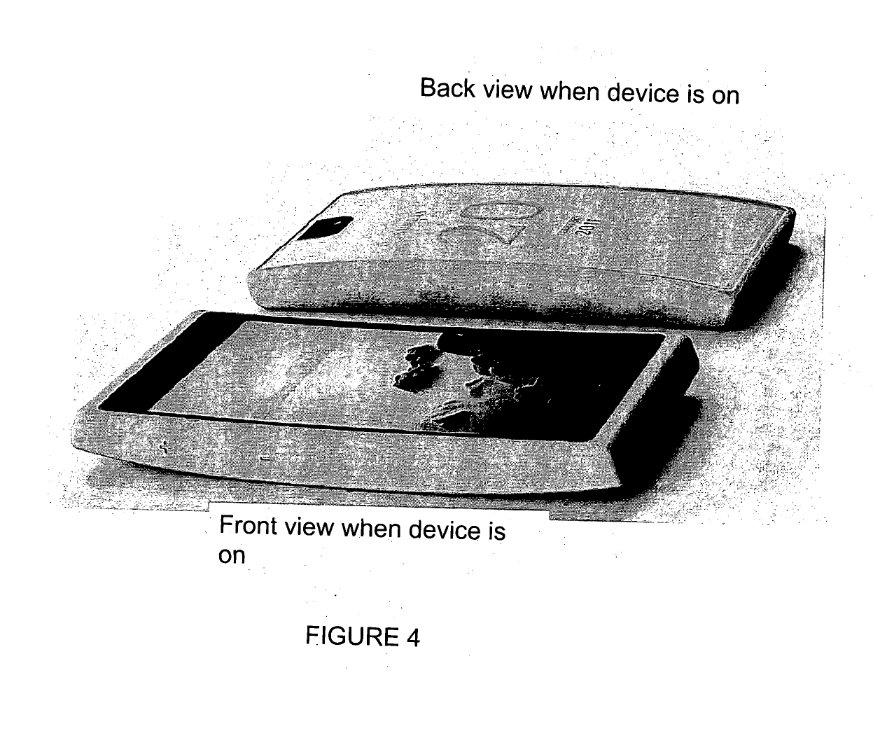

The bar form factor display device or display device assembly (eg. a phone) including its detachable casing may have a unique and organic shape—essential for rapid product differentiation in a crowded space. Examples are shown in FIGS. 3 and 4. The bar form factor display device assembly including its detachable casing may have a concave front face and a convex rear face. The magnitude of the curvature of the faces may be the same or similar. The concave front may match the path of a finger as the user's wrist rotates. Hence it's very natural to use. Having a curved surface as the vibrating distributed mode loudspeaker (DML) speaker is also better since if the front display with the speaker exciters was instead a flat surface, then it would sound unpleasant if that flat surface is placed down against a tabletop. Curving the surface prevents this happening. Preferred curvature of front and back is cylindrical, but spherical or aspherical are possible. The convex back can have a bistable display. Since the normal resting position is front face down, the back screen with bi-stable display is normally displayed when the bar form factor display device is in the resting position. This resting position is mechanically stable. If bar form factor display device or display device assembly including its detachable casing is placed back down (ie convex face down), the bar form factor display device or display device assembly including its detachable casing could spin, which is unstable. Hence a user will likely place the bar form factor display device or display device assembly including its detachable casing front face (i.e. concave face) down, with the bi-stable screen showing.

If the bar form factor display device or display device assembly including its detachable casing is in a pocket, the front face (concave face) can face inwards, since this better matches leg curvature. This can be the better configuration (as opposed to front face up) for antenna reception.

In manufacturing, the curved shape may be laminated to glass.

DML Bar Form Factor Display Device Assembly (Eg. Phone) Speaker

It's hard to get good quality audio performance, unless you have a large speaker with a large and ugly speaker hole. In one example, we use NXT plc distributed mode loudspeaker (DML) technology here to vibrate the entire bar form factor display device (eg. phone) screen—the whole screen surface acts as the speaker. The speaker hole can be fully eliminated. One can use two small drivers/exciters under the glass to make the screen vibrate. DML has never been used before to drive a screen surface in a mobile phone or a bar form factor display device. Haptic feedback can be provided by the drivers too—a new use for the DML exciters.

Device audio properties may be characterized by:

### On-board Audio: 128-Voice Polyphony,

### QconcertPlus, Dolby 5.1 Surround,

### Echo and Noise Cancellation.

### Additional ANC (Audience).

### 2 Microphones.

NXT display surface sound (No speakers)
Deep stereo Surface Sound
No conventional speakers

### Adaptive Noise Cancellation

The bar form factor display device's case and the detachable case materials may be characterized by:

Case: Single block

### Materials: Plastic or Texin™

A hinged (eg. clam shell) phone or phone assembly including its detachable casing may be provided which includes, in addition to a main display which is concealed when the phone is in a closed configuration, two bi-stable displays, one on each major face of the phone when the device is in a closed configuration. One bi-stable display forms part of the detachable casing. This ensures that even when the device is in a closed configuration, received messages may be displayed on both bistable screens so that the received messages are visible to a user even when the phone is in the closed configuration, irrespective of which major face is facing upwards when the device is lying on a surface such as a table surface.

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred example(s) of the invention, it will be apparent to those of ordinary skill in the art that numerous modifications can be made without departing from the principles and concepts of the invention as set forth herein.

### Concepts

There are multiple concepts, described as concepts ‘A-L’, in this disclosure. The following may be helpful in defining these concepts. Elements of concepts A to L may be combined.

a. Method of Installing a Driver to Emulate a Network Card (Eg. An Ethernet Card) or WWAN Device (Card)

There is provided a method of installing a driver to emulate a network card for communicating between a host and a device, wherein a host operating system class of the host is detected from the device side, comprising the steps of:
(i) detecting the host operating system class from the device side by USB enumeration;
(ii) attempting to install a first driver to emulate a network card on the host corresponding to the detected host operating system class, wherein the installed first driver is operable to enable communication between the host and the device, and terminating the method if the first driver is successfully installed.

Further aspects of the method may include:
further comprising the step of:
   (iii) If the first driver installation in (ii) is unsuccessful, attempting to install a second driver to emulate a network card on the host corresponding to an operating system class different to the detected host operating system class, wherein the installed second driver is operable to enable communication between the host and the device, and terminating the method if the second driver is successfully installed.
a driver to emulate a network card is a driver to emulate a network card over USB protocol, eg. Ethernet-over-USB protocol, or WWAN.
the attempt in (ii) is limited to a predetermined time period, or to a predetermined number of attempts.
the attempt in (iii) is limited to a predetermined time period, or to a predetermined number of attempts.
the method further comprises the step of:
   (iv) Repeating step (iii) once each for each different operating system class in a set of different operating system classes until a successful driver installation occurs, wherein the successfully installed driver is operable to enable communication between the host and the device, and terminating the method if the successfully installed driver is successfully installed.
each attempt in (iv) is limited to a corresponding predetermined time period, or to a predetermined number of attempts.
the method further comprises the step of:
   (iv) Repeating steps (ii) and (iii) for each different operating system class in a set of different operating system classes until a successful driver installation occurs, wherein the successfully installed driver is operable to enable communication between the host and the device, and terminating the method if the successfully installed driver is successfully installed.
each attempt in (iv) is limited to a corresponding predetermined time period, or to a predetermined number of attempts.
the method further comprises the step of:
   (v) If all attempts at driver installation are unsuccessful, prompting a user to connect a physical medium to the host, to install a driver to communicate between the host and the device.
the physical medium is a CD-ROM, and connection includes inserting the CD-ROM into a host CD-ROM drive.
further comprising the step of driver installation by autorun from the CD-ROM.
further comprising the step of driver installation by manual installation from the CD-ROM.
the physical medium is a USB-FLASH drive, or hard disk drive, and connection includes connecting the USB-FLASH drive or hard disk drive to the host.
a physical medium for driver installation is emulated and mounted automatically.
the method further comprises the step of:
   (v) If all attempts at driver installation are unsuccessful, prompting a user to connect the host to a server supplying drivers relating to the host operating system, to install a driver to communicate between the host and the device.
further comprising the step of: downloading the driver to the host from the server supplying drivers relating to the host operating system, and installing the driver on the host.
a detected host operating system class is Windows supporting RNDIS, and an operating system class different to the detected host operating system class is Mac/Linux.
a detected host operating system class is Mac/Linux, and an operating system class different to the detected host operating system class is Windows supporting RNDIS.
a detected host operating system class is Mac/Linux supporting WWAN, and an operating system class different to the detected host operating system class is Mac/Linux supporting CDC-ECM.
a detected host operating system class of step (ii) is Mac/Linux supporting WWAN, an operating system class of step (iii) different to the detected host operating system class is Mac/Linux supporting CDC-ECM, and an operating system class of step (iv) is Windows supporting RNDIS.
further comprising the step of terminating the method if installation of a driver to emulate a network card on the host corresponding to the detected host operating system class is unsuccessful.
further comprising the step of terminating the method if installation in step (iii) is unsuccessful.
further comprising the steps of repeating step (ii) and step (iii) if installation in step (iii) is unsuccessful.
further comprising the step of terminating the method if installation in step (iv) is unsuccessful for each different operating system class.
further comprising the steps of repeating step (ii), step (iii) and step (iv) if installation in step (iv) is unsuccessful.
the set of different operating system classes contains at least three different operating system classes.
the driver to emulate a network card for communicating between the host and the device is for wireless communication between the host and the device.

There is provided a system implementing the method of any of the above statements, the system comprising the host and the device.

Further aspects of the system may include:
the device is a mobile communications device.
the mobile communications device is operable to provide instant and automatic sharing of a wireless network in response to a single action by a user, the single action comprising a physical contact gesture with the mobile device by the user, or a voice activation command by the user.
the device is a portable router device including a wide area network interface and a local area network interface, the portable router device operable to connect to a wide area network using the wide area network interface, the portable router device further operable to provide a local area network using the local area network interface in response to the device connection with the wide area network satisfying a connection condition.
the device is a wireless data enabled USB dongle operable to receive streamed files.
the device is a wireless data enabled USB dongle operable to provide internet access.
the device is a bar form factor display device comprising front and back major faces, the front major face arranged to present a first display screen and the back major face arranged to present a second display screen different to the first display screen.
the device is a display device assembly including a bar form factor display device and a detachable casing, the assembly operable to be assembled wherein the detachable casing is in attachment with the bar form factor display device, the assembly when assembled comprising front and back major faces, wherein the front major face is arranged to present a first display screen which forms part of the bar form factor display device, and wherein the back major face is arranged to present a second display screen different to the first display screen, which forms part of the detachable casing.

There is provided a computer program product operable when installed on a USB device to perform a method of installing a driver to emulate a network card for communicating between a host and the device, wherein a host operating system class of the host is detected from the device side, comprising the steps of:
(i) detecting the host operating system class from the device side by USB enumeration;
(ii) attempting to install a first driver to emulate a network card on the host corresponding to the detected host operating system class, wherein the installed first driver is operable to enable communication between the host and the device, and terminating the method if the first driver is successfully installed.

Further aspects of the computer program product may include:
further operable to perform the method step of:
   (iii) If the first driver installation in (ii) is unsuccessful, attempting to install a second driver to emulate a network card on the host corresponding to an operating system class different to the detected host operating system class, wherein the installed second driver is operable to enable communication between the host and the device, and terminating the method if the second driver is successfully installed.
further operable to perform the method steps of any of the above statements.

### B. Method of Protocol Switching

Method of protocol switching between a host and a device, the method comprising the steps of:

(i) the device emulating RNDIS protocol;
(ii) the device waiting for a response from the host for a predetermined time, and terminating the method if successful;
(iii) if unsuccessful, the device emulating CDC protocol;
(iv) the device waiting for a response from the host for a predetermined time, and terminating the method if successful;
(v) if unsuccessful, the device emulating a mass storage device;

Further aspects of the method may include:
the emulated mass storage device providing drivers for operating systems which do not include the driver pre-installed.
if the sequence provides no response from the host side, the sequence is repeated.

### C. Method of Protocol Switching

Method of protocol switching between a host and a device, the method comprising the steps of:

(i) the device emulating a first network protocol over USB (eg. Ethernet-over-USB protocol) or WWAN;
(ii) the device waiting for a response from the host for a predetermined time, and terminating the method if successful;
(iii) if unsuccessful, the device emulating a second network protocol over USB (eg. Ethernet-over-USB protocol) or WWAN, different to the first network protocol over USB or WWAN;
(iv) the device waiting for a response from the host for a predetermined time, and terminating the method if successful;
(v) if unsuccessful, the device emulating a mass storage device;

Further aspect of the method may include:
the emulated mass storage device providing drivers for operating systems which do not include the driver pre-installed.
first Ethernet-over-USB protocol is RNDIS and second Ethernet-over-USB protocol is CDC.
first Ethernet-over-USB protocol is CDC and second Ethernet-over-USB protocol is RNDIS.
if the sequence provides no response from the host side, the sequence is repeated.

### D. Method of Protocol Switching

Method of protocol switching between a host and a device, the method comprising the steps of:

(i) the device emulating RNDIS protocol;
(ii) the device waiting for a response from the host for a predetermined time, and terminating the method if successful;
(iii) if unsuccessful, the device emulating CDC protocol;
(iv) the device waiting for a response from the host for a predetermined time, and terminating the method if successful.

Further aspects of the method may include:
(v) if unsuccessful, the device emulating a mass storage device.
the emulated mass storage device providing drivers for operating systems which do not include the driver pre-installed.
if the sequence provides no response from the host side, the sequence is repeated

### E. Method of Protocol Switching

Method of protocol switching between a host and a device, the method comprising the steps of:

(i) the device emulating a first network protocol over USB (eg. Ethernet-over-USB protocol) or WWAN;
(ii) the device waiting for a response from the host for a predetermined time, and terminating the method if successful;
(iii) if unsuccessful, the device emulating a second network protocol over USB (eg. Ethernet-over-USB protocol) or WWAN, different to the first network protocol over USB (eg. Ethernet-over-USB protocol) or WWAN;
(iv) the device waiting for a response from the host for a predetermined time, and terminating the method if successful.

Further aspect of the method may include:
(v) if unsuccessful, the device emulating a mass storage device;
the emulated mass storage device providing drivers for operating systems which do not include the driver pre-installed.
first Ethernet-over-USB protocol is RNDIS and second Ethernet-over-USB protocol is CDC.
first Ethernet-over-USB protocol is CDC and second Ethernet-over-USB protocol is RNDIS.
if the sequence provides no response from the host side, the sequence is repeated.

### F. Bar Form Factor Display Device Assembly

There is provided a display device assembly including a bar form factor display device and a detachable casing, the assembly operable to be assembled wherein the detachable casing is in attachment with the bar form factor display device, the assembly when assembled comprising front and back major faces, wherein the front major face is arranged to present a first display screen which forms part of the bar form factor display device, and wherein the back major face is arranged to present a second display screen different to the first display screen, which forms part of the detachable casing.

The first display screen may be called the front display screen. The second display screen may be called the back display screen. The above may include additionally any of the following, alone or in combination:
the bar form factor display device includes a first battery and wherein the detachable casing includes a second battery.
When the assembly is assembled, the second battery is operable to charge the first battery.
when the assembly is assembled, the second battery is operable to power the bar form factor display device.
when the assembly is assembled, a data connection is formed between the bar form factor display device and the detachable casing.
the data connection is a wired data connection.
the data connection is a wireless data connection.
the bar form factor display device includes a first port and the detachable case includes a second port, wherein when the assembly is assembled the first port is in connection with the detachable case, and the second port provides a connectivity of the assembly which is equivalent to a connectivity of the first port when the bar form factor display device is in isolation.
the second port provides a connectivity of the assembly which is a wired connectivity.
the second port provides a connectivity of the assembly which is a wireless connectivity.
one of the bar form factor display device and the detachable casing includes a magnet and the other of the bar form factor display device and the detachable casing includes a material capable of magnetic attraction, wherein the bar form factor display device and the detachable casing are arranged such that a magnetic force between the magnet and the material capable of magnetic attraction is sufficiently large to pull the detachable casing firmly into contact with the bar form factor display device.
the bar form factor display device and the detachable casing comprise mating guide surfaces which are arranged to guide the detachable case to a correct position for connection with the bar form factor display device.
the bar form factor display device includes external electrical contact elements and the detachable casing includes external electrical contact elements.
the contact includes an electrical contact between the external electrical contact elements in the detachable module and in the device.
the second display screen is a low power display screen.
the second display screen uses electrowetting technology.
the second display screen is a bi-stable display screen.
Bar form factor display device is a slate device.
Bar form factor display device is a bar or candybar device.
Bar form factor display device is a slab-shaped form.
Bar form factor display device assembly detachable casing displays an image in the off state.
Bar form factor display device assembly detachable casing displays an image in a low power notification mode.
Bar form factor display device assembly detachable casing displays an image on the bi-stable display in the off state or in a low power notification mode.
Bar form factor display device first display screen is a liquid crystal display screen.
Bar form factor display device first display screen is an active-matrix organic light-emitting diode display screen.
Device assembly appearance is context related.
Context related device assembly appearance includes location-based advertising
Context related device assembly appearance includes results of a location-based search.
The look of the device assembly can be changed by changing what is displayed on the bi-stable screen.
The device assembly skin can be changed.
The device assembly skin is one or more of wallpaper, photos, movies, user-customized content.
The look of the device assembly can be changed by changing what is displayed on the bi-stable screen to give the appearance of a different phone case.
There is provided a bi-stable active matrix and high-resolution display on the back panel of the device assembly.
Regarding the back panel, user is able to display a pattern, picture or application interface to differentiate their phone from others.
any application or service executing on the device assembly is able to display a notification on the back screen.
Notification time is not limited, because a bi-stable display is used.
The information remains on the back screen even when the phone itself is switched off.
in the off-state, the bi-stable display on the back face continues to display content, which can be viewed using external illumination.
the back face has an E-ink bi-stable display.
the front face has an AMOLED display, and the back face has an E-ink bi-stable display.
In the on state, the front face is back-illuminated and can display an image or other content; in the on-state, the bi-stable display on the back face also can display an image or other content.
front display is touch screen.
back screen is: Electronic Paper Display under glass.
back screen is: Grayscale panel.
back screen is: interferometric modulation technology panel.
back face is: perceived as part of case.
back face has low power consumption.
back screen resolution is similar to front display resolution.
back screen provides approximately at least 1000 full screen updates using 300 mAh of charge for a screen size of approximately 4 inches.
back screen update rate is the order of twice per minute.
back screen does not consume power or require power when in bi-stable state.
back screen output provides one or more of: Interactions, Control, Use cases, Personalization, Widgets, Privacy.
back screen output provides Social aggregator output.
back screen output provides Latitude & Longitude eg. those of the device.
back screen output provides Location eg. device location.
back screen output provides Notifications.
back screen output provides Operator Push output.
back screen output provides news provided by a news service.
back screen output provides social messages provided by a social messaging service.
back screen output provides an indication of mobile phone signal strength.
back screen output provides an indication of battery charge state.
back screen output provides calendar information.
back display of the device assembly is the only operational display of the device assembly when the device assembly operates in a low power notification mode.
when the device assembly operates in a low power notification mode, the back display of the device assembly displays content updates of one or more categories.
when the device assembly operates in a low power notification mode, the back display of the device assembly displays content updates of one or more categories, the categories including one or more of news, social messages, an emergency notification, financial news, earthquake, tsunami or weather.
when the device assembly operates in a low power notification mode, the back display of the device assembly displays content updates of one or more categories, wherein the categories are preselected
when the device assembly operates in a low power notification mode, the back display of the device assembly displays content updates of one or more categories, wherein the categories are preselected by a user
when the device assembly operates in a low power notification mode, the back display of the device assembly displays content updates of one or more categories, wherein the categories are preselected by a network services provider.
Bar form factor display device assembly, wherein an application or service executing on the device assembly is able to display a notification on the first screen.
Bar form factor display device assembly, wherein any application or service executing on the device assembly is able to display a notification on the first screen.
Bar form factor display device assembly, wherein a message is provided on first screen and on second screen.
Bar form factor display device assembly, wherein the second display screen output provides a social network screen.
Bar form factor display device assembly, wherein the second display screen output provides social aggregator output or social network output.
Bar form factor display device assembly, wherein the social aggregator output or social network output is a Facebook page.
Bar form factor display device assembly, wherein the second display screen output provides a Google search page.
device assembly is portable.
device assembly is a mobile phone, a portable digital assistant, a laptop, or a tablet computer.
device assembly includes a virtual keyboard.
device assembly has a touch screen.
device assembly has two screens each of which is a touch screen.
bi-stable screen is a touch screen.
bi-stable screen is not a touch screen.
A screen that is not a bi-stable screen is a touch screen.
device assembly includes a second bi-stable screen.
device assembly includes a second bi-stable screen which is a touch screen.
device assembly includes a second bi-stable screen which is not a touch screen.
bi-stable screen occupies greater than 70% of the area of the major face of the device assembly on which it is located.
bi-stable screen occupies greater than 90% of the area of the major face of the device assembly on which it is located.
bi-stable screen occupies greater than 95% of the area of the major face of the device assembly on which it is located.
screen other than the bi-stable screen occupies greater than 70% of the area of the major face of the device assembly on which it is located.
screen other than the bi-stable screen occupies greater than 90% of the area of the major face of the device assembly on which it is located.
screen other than the bi-stable screen occupies greater than 95% of the area of the major face of the device assembly on which it is located.
A second bi-stable screen occupies greater than 70% of the area of the major face of the device assembly on which it is located.
A second bi-stable screen occupies greater than 90% of the area of the major face of the device assembly on which it is located.
A second bi-stable screen occupies greater than 95% of the area of the major face of the device assembly on which it is located.
device comprises a single backlight module situated between its two major faces.
single backlight module illuminates one display on one major face.
single backlight module illuminates two displays each of which is situated on a different major face of the device assembly to the other display
device comprises two backlight modules, each of which illuminates a display situated on a major face of the device assembly
the two backlight modules each illuminates a respective display on a respective major face of the device assembly
The two backlight modules are situated between two displays of the device assembly, where each display is situated on a different major face of the device assembly to the other display.

### G. Bar Form Factor Display Device

Bar form factor display device corresponding to the Bar form factor Display Device Assembly of concept F, except that here Bar form factor display device is provided as an integrated device.

### H. Method of Providing Notification Messages in a Bar Form Factor Display Device Assembly at Low Power

Method of providing notification messages on a display device assembly including a bar form factor display device and a detachable casing, the device assembly operable at low power, the assembly when assembled comprising front and back major faces, wherein the front major face is arranged to present a first display screen which forms part of the bar form factor display device, and wherein the back major face is arranged to present a second display screen different to the first display screen which forms part of the detachable casing, wherein the second display screen is a low power display screen, comprising the steps of:
i) Executing software on the device assembly, the software operating the device assembly in a low power notification mode in which the first display screen is off and in which the device assembly is operable to receive a notification message;
ii) The software on the device assembly receiving a notification message, and
iii) Displaying the notification message on the low power display screen.

The first display screen may be called the front display screen. The second display screen may be called the back display screen. The above may include additionally any of the following, alone or in combination:
Low power display screen is a bi-stable display screen.
The software determines if the notification message is a new notification message, and the bi-stable display screen is updated only if the notification message is a new notification message.
notification messages are from a notification message provider.
The software on the device receiving a notification message from a notification message provider.
Displaying the notification message on the bi-stable display screen at a low screen update frequency.
the notification message comprises an image.
the notification message comprises text.
an application or service executing on the device assembly is able to display a notification message on the back screen.
any application or service executing on the device assembly is able to display a notification message on the back screen.
Notification message display time is not limited, because a bi-stable display is used.
Notification message remains on the back screen even when the phone itself is switched off.
the back face has an E-ink bi-stable display.
back screen is: Electronic Paper Display under glass.
back screen uses interferometric modulation display technology.
back screen resolution is similar to front display resolution.
back screen provides approximately at least 1000 full screen updates using 300 mAh of charge for a screen size of approximately 4 inches.
back screen update rate is the order of twice per minute.
Notification message is of one or more categories, the categories including one or more of news, social messages, an emergency notification, financial news, earthquake, tsunami or weather.
Notification message is a social network message provided on a social network screen.
Notification message is a social network message provided on a Facebook page.
Notification message is a social message provided by a social messaging service.
Notification message is a social message provided by a social networking service.
Notification message is of one or more categories, wherein the categories are preselected.
Notification message is of one or more categories, wherein the categories are preselected by a user.
Notification message is of one or more categories, wherein the categories are preselected by a network services provider.
Notification message is text message from a blog site.
Notification message is privacy controlled.
Maximum screen update frequency is a user settable parameter in the software.
device assembly is portable.
the device assembly is a mobile phone, a portable digital assistant, a laptop, a digital audio player (eg. ipod), or a tablet computer (eg. ipad).
device assembly includes a virtual keyboard.
device assembly has a touch screen.
Including the step of changing the skin of the bi-stable display screen.
The step of changing the skin of the bi-stable display screen comprises providing a skin which is one or more of: wallpaper, photos, movies, or user-customized content.
Including the step of providing context-related content on the bi-stable display screen.
The step of providing context-related content on the bi-stable display screen includes providing location-based advertising.
The step of providing context-related content on the bi-stable display screen includes providing results of a location-based search.

### I. Method of Providing Notification Messages in a Bar Form Factor Display Device at Low Power

Method of providing notification messages in a bar form factor display device at low power corresponding to the Method of providing notification messages in a bar form factor display device assembly at low power of concept H, except that here a Bar form factor display device corresponds to the Bar form factor Display Device Assembly.

J. Portable Router Device Operable to Provide a Local Area Network in Response to the Device Connection with a Wide Area Network Satisfying a Connection Condition.

There is provided a portable router device including a wide area network interface and a local area network interface, the portable router device operable to connect to a wide area network using the wide area network interface, the portable router device further operable to provide a local area network using the local area network interface in response to the device connection with the wide area network satisfying a connection condition. Further aspects may include:
the wide area network interface is operable to provide a wireless connection.
the connection condition includes that the device is connected to the wide area network.
the connection condition includes wide area network signal strength being in a predefined range of wide area network signal strength.
the local area network interface is operable to provide a wireless connection.
the local area network interface includes a Wi-Fi interface.
the local area network interface includes a personal network interface.
the local area network interface includes a campus network interface.
the local area network interface is operable to provide a wired connection.
the portable router device is a mobile device.
the portable router device is further operable to provide the local area network using the local area network interface only when the device connection with the wide area network satisfies the connection condition.
the portable router device is further operable to deactivate the local area network using the local area network interface in response to a disconnection of the device from the wide area network.
the portable router device is further operable to deactivate the local area network using the local area network interface in response to wide area network signal strength being in a predefined range of wide area network signal strength.
the portable router device is further operable to deactivate the local area network using the local area network interface in response to a predefined range of wide area network signal strength occurring for a predefined time interval.
the portable router device is further operable to maintain the local area network activation in response to a communication between devices on the local area network.
the router device when switched on reduces power consumption when the local area network interface is deactivated.
the router device includes a display.
the display is operable to display a message indicating that a local area network interface is not provided.
the display is operable to display a message indicating that a local area network interface is not provided because a wide area network is not available.
the display is operable to display a message indicating that a local area network interface is not provided because a wide area network signal is too weak.
the device is operable to provide instant and automatic sharing of a wireless network in response to a single action by a user, the single action comprising a physical contact gesture with the portable router device by the user, or a voice activation command by the user.
the portable router device includes a hard switch, wherein the single gesture by the user comprises pressing the hard switch of the portable router device.
the portable router device includes a soft switch, wherein the single gesture by the user comprises pressing the soft switch of the portable router device.
the portable router device includes a hidden mechanical button, wherein the single gesture by the user comprises pressing the hidden mechanical button of the portable router device.
the portable router device includes a squeeze control, wherein the single gesture by the user comprises activating the squeeze control of the portable router device.
the portable router device includes capacitor sensor strips operable to detect when the user has picked up the device, wherein the single action by the user comprises picking up the portable router device.
the device is operable to connect to the internet via a mobile phone network.
the device is adapted to enable a further device to access files on the portable router device via the local area network.
the device is connectable to a 4G mobile phone network.
the device is connectable to a 3G mobile phone network.
the device is connectable to a 2G mobile phone network.
the device is a bar form factor device.
the device comprises a touch screen.
the device comprises a further bistable screen.
the bistable screen is operable to be refreshed wholly or partially.
the bistable screen is operable to be refreshed starting with any pixel in a screen area.
the device is operable to define a limited set of users who may connect to the device to enable sharing of the local area network with the limited set of users.
the device is operable to provide a wireless connection to a personal computer, to enable that computer to connect to the internet.
the device is operable to provide a wireless connection to two personal computers, to enable file sharing or resource sharing between those two personal computers.
the device is operable to provide for file synchronization for files that are shared using sharing of a local area network via the portable router device.
the device is a mobile phone.
the device is a video game console.
the device is a smartphone.
the device is a digital audio player.
the device is a personal computer.
the device is a tablet computer.
the device is a personal device.
the device is operable to provide instant and automatic sharing of a wireless network in response to a single action by a user, the single action comprising a physical contact gesture with the portable router device by the user, or a voice activation command by the user, when the portable router device is already turned on and connected to a mobile phone network.
the device is operable to connect to a wireless dongle, the portable router device further operable to view a file structure of files stored on the wireless dongle.
the device is operable to view the file structure of files stored on the wireless dongle in a web browser running on the portable router device.
the device is operable to print a file on the dongle at a printer in connection with the dongle.
the device is operable to print a file on the dongle at a printer in connection with the portable router device.
the device has a curved shape.
the device has a concave front face and a convex rear face.
the concave front face and the convex rear face have a similar magnitude of curvature.

There is provided a method of providing a local area network using a portable router device, the device including a wide area network interface and a local area network interface, the portable router device operable to connect to a wide area network using the wide area network interface, the portable router device further operable to provide a local area network using the local area network interface, the method comprising the step of:
(i) the portable router providing the local area network in response to the device satisfying a connection condition with the wide area network.

The method may further comprise the step of:

(ii) the portable router deactivating the local area network in response to the device not satisfying a connection condition to the wide area network.

There is provided a computer program product adapted to provide a local area network when the program is executing on a portable router device, the device including a wide area network interface and a local area network interface, the portable router device operable to provide the local area network using the local area network interface, the computer program product adapted to connect the portable router device to a wide area network using the wide area network interface, the computer program product further adapted to provide the local area network in response to the device satisfying a connection condition with the wide area network.

The computer program product may be further adapted to deactivate the local area network in response to the device not satisfying a connection condition with the wide area network.

K. USB Dongle for Internet Access or for Streamed Files, Eg. Audio (Eg. Internet Radio), Video or Image Files

There is provided a wireless data enabled USB dongle operable to provide internet access, or to receive streamed files. Further features may include:
Files may be audio, video, or images.
streamed audio is internet radio
USB dongle may interface wirelessly with a mobile phone or other mobile device (eg. a portable router device)
The mobile phone or other mobile device may provide automatic wireless network sharing
USB dongle operable to connect to an in-vehicle USB socket, wherein an in-vehicle computer system is operable to play audio files on the dongle.
mobile phone or other mobile device may provide wireless access to the internet
mobile phone or other mobile device may provide wireless access to the internet, wherein access is provided via the internet to radio stations that cannot be received by a vehicle radio broadcast receiver
USB dongle operable to capture a data stream and converts it to a sequence of files
Files may be MP3 files
Files may be audio files
Files may be video files
Files may be images
USB dongle enables an in-vehicle (eg. in-car) audio system to have playback/rewind, store etc. functionality for audio files.
USB dongle enables an in-vehicle (eg. in-car) display system to have playback/rewind, store etc. functionality for video files.
USB dongle enables an in-vehicle (eg. in-car) display system to have step forward, step backward, store etc. functionality for image files.
streamed audio is stored as at least two separate files, which allows the user to choose to skip to the next track using the car audio system software.
streamed video is stored as at least two separate files, which allows the user to choose to skip to the next track using the car video system software.
The user can listen to audio (eg. music) online in his vehicle (eg. a car) with no modifications to the in-vehicle (eg. in-car) audio system.
The user can view video online in his vehicle (eg. a car) with no modifications to the in-vehicle (eg. in-car) video system.
An online interface is used for setting up the service, selecting stream source.
The online interface may be provided by the mobile phone or other mobile device.
Dongle may be a USB stick for in-vehicle audio

### L. Mobile Device Operable to Provide Instant and Automatic Sharing of a Wireless Network in Response to a Single Action by a User

There is provided a mobile device operable to provide instant and automatic sharing of a wireless network in response to a single action by a user, the single action comprising a physical contact gesture with the mobile device by the user, or a voice activation command by the user. Further features may include:
The mobile device may be operable to connect to the internet via a mobile phone network.
The mobile device may be such that a second device is wirelessly connectable to the mobile device via the shared wireless network.
The mobile device may be such that a plurality of devices are wirelessly connectable to the mobile device via the shared wireless network.
The mobile device may be adapted to enable the second device or the plurality of devices to access the internet via the shared wireless network.
The mobile device may be adapted to enable the second device or the plurality of devices to access files on the mobile device via the shared wireless network.
The mobile device may include a hard switch, wherein the single gesture by the user comprises pressing a hard switch of the mobile device.
The mobile device may include a soft switch, wherein the single action by the user comprises pressing the soft switch of the mobile device.
The mobile device may include a hidden mechanical button, wherein the single action by the user comprises pressing the hidden mechanical button of the mobile device.
The mobile device may include a squeeze control, wherein the single action by the user comprises activating the squeeze control of the mobile device.
The mobile device may include capacitor sensor strips operable to detect when the user has picked up the device, wherein the single action by the user comprises picking up the mobile device.
The mobile device may be connectable to a 4G mobile phone network.
The mobile device may be connectable to a 3G mobile phone network.
The mobile device may be connectable to a 2G mobile phone network.
The mobile device may be a bar form factor device.
The mobile device may comprise a touch screen and a further bistable screen.
The mobile device may be one wherein the bistable screen is operable to be refreshed wholly or partially.
The mobile device may be one wherein the bistable screen is operable to be refreshed starting with any pixel in a screen area.
The mobile device may be one wherein the mobile device is operable to define a limited set of users who may connect to the device to enable instant and automatic sharing of a wireless network with the limited set of users.
The mobile device may be one wherein the mobile device is operable to provide a wireless connection to a personal computer, to enable that computer to connect to the internet.
The mobile device may be one wherein the mobile device is operable to provide a wireless connection to two personal computers, to enable file sharing or resource sharing between those two personal computers.
The mobile device may be one wherein the mobile device is operable to provide for file synchronization for files that are shared using automatic sharing of a wireless network via the mobile device.
The mobile device may be a mobile phone.
The mobile device may be a video game console.
The mobile device may be a smartphone.
The mobile device may be a digital audio player.
The mobile device may be a personal computer.
The mobile device may be a tablet computer.
The mobile device may be a personal portable device.
The mobile device may be operable to provide instant and automatic sharing of a wireless network in response to a single action by a user, the single action comprising a physical contact gesture with the mobile device by the user, or a voice activation command by the user, when the device is already turned on and connected to a mobile phone network.
The mobile device may be operable to connect to a wireless dongle, the mobile device further operable to view a file structure of files stored on the wireless dongle.
The mobile device may be operable to view the file structure of files stored on the wireless dongle in a web browser running on the mobile device.
The mobile device may be operable to print a file on the dongle at a printer in connection with the dongle.
The mobile device may be operable to print a file on the dongle at a printer in connection with the mobile device.
The mobile device may be one wherein the device is in connection with the internet, the device further operable to connect to a wireless dongle, the mobile device further operable to stream audio, video or image files to the wireless dongle in response to a request from the wireless dongle to the mobile device to access a streaming source via the internet.
The mobile device may have a curved shape.
The mobile device may have a concave front face and a convex rear face.
The mobile device may be one wherein the concave front face and the convex rear face have a similar magnitude of curvature.
The mobile device may be one wherein the device is further operable to disable the sharing of the wireless network in response to a further single action by the user, the further single action comprising a physical contact gesture with the mobile device by the user, or a voice activation command by the user.
The mobile device may include a hard switch, wherein the further single action by the user comprises pressing the hard switch of the mobile device.
The mobile device may include a soft switch, wherein the further single action by the user comprises pressing the soft switch of the mobile device.
The mobile device may include a hidden mechanical button, wherein the further single action by the user comprises pressing the hidden mechanical button of the mobile device.
The mobile device may include a squeeze control, wherein the further single action by the user comprises activating the squeeze control of the mobile device.
The mobile device may include capacitor sensor strips operable to detect when the user has picked up the device, wherein the further single action by the user comprises picking up the mobile device.
The mobile device may be one wherein the shared wireless network is a Wi-Fi network.
The mobile device may be one wherein a device local wireless network interface of the mobile device is powered down when a mobile phone network signal strength is below a predefined level.
The mobile device may be one wherein the device local wireless network interface of the mobile device is powered down when the mobile phone network signal strength is below the predefined level for a predefined time interval.
The mobile device may be one wherein the device local wireless network interface of the mobile device is powered down when the device is not connected to a mobile phone network.
The mobile device may be one wherein the device local wireless network interface of the mobile device is powered down when the device is not connected to a mobile phone network for a predefined time interval.
The mobile device may be one wherein the device local wireless network interface of the mobile device is not powered down when the device is acting as a router between other devices on the local wireless network.

Method of providing instant and automatic sharing of a wireless network in response to a single action by a user of a mobile device, comprising the step of providing instant and automatic sharing of the wireless network in response to the single action by the user, the single action comprising a physical contact gesture with the mobile device by the user, or a voice activation command by the user.

Computer program product operable to provide instant and automatic sharing of a wireless network in response to a single action by a user of a mobile device, the computer program product when running on the mobile device operable to provide instant and automatic sharing of the wireless network in response to the single action by the user, the single action comprising a physical contact gesture with the mobile device by the user, or a voice activation command by the user.

### APPENDIX

### Communication Protocols

The Remote Network Driver Interface Specification (RNDIS) is a Microsoft proprietary protocol used mostly on top of USB. It provides a virtual Ethernet link to most versions of the Windows operating system. A partial RNDIS specification is available from Microsoft, but Windows implementations have been observed to issue requests not included in that specification, and to have undocumented constraints. In addition, the protocol is tightly coupled to Microsoft's programming interfaces and models, most notably the Network Driver Interface Specification (NDIS), which are alien to operating systems other than Windows. These issues complicate third-party implementations.

The USB Implementers Forum (USB-IF) defines at least three non-proprietary USB Communications Device Class (CDC) protocols with comparable “virtual Ethernet” functionality; one of them (CDC-ECM) predates RNDIS and is widely used for interoperability with non-Microsoft operating systems, but it has no native Windows support.

A wireless wide area network (WWAN), is a form of wireless network. The larger size of a wide area network compared to a local area network requires differences in technology. Wireless networks of all sizes deliver data in the form of telephone calls, web pages, and streaming video.

A WWAN often differs from wireless local area network (WLAN) by using mobile telecommunication cellular network technologies such as LTE, WiMAX (often called a wireless metropolitan area network or WMAN), UMTS, CDMA2000, GSM, cellular digital packet data (CDPD) and Mobitex to transfer data. It can also use Local Multipoint Distribution Service (LMDS) or Wi-Fi to provide Internet access. These technologies are offered regionally, nationwide, or even globally and are provided by a wireless service provider. WWAN connectivity allows a user with a laptop and a WWAN card to surf the web, check email, or connect to a virtual private network (VPN) from anywhere within the regional boundaries of cellular service. Various computers can have integrated WWAN capabilities.

Since radio communications systems do not provide a physically secure connection path, WWANs typically incorporate encryption and authentication methods to make them more secure.

1. A method of installing a driver to emulate a network card for communicating between a host and a device, wherein a host operating system class of the host is detected from the device side, comprising the steps of:
(i) detecting the host operating system class from the device side by USB enumeration;
(ii) attempting to install a first driver to emulate a network card on the host corresponding to the detected host operating system class, wherein the installed first driver is operable to enable communication between the host and the device, and terminating the method if the first driver is successfully installed.

2. Method of claim 1, further comprising the step of:
(iii) If the first driver installation in (ii) is unsuccessful, attempting to install a second driver to emulate a network card on the host corresponding to an operating system class different to the detected host operating system class, wherein the installed second driver is operable to enable communication between the host and the device, and terminating the method if the second driver is successfully installed.

3. Method of claim 1, wherein a driver to emulate a network card is a driver to emulate a network card over USB protocol.

4. Method of claim 1, wherein the attempt in (ii) is limited to a predetermined time period, or to a predetermined number of attempts.

5. Method of claim 2, wherein the attempt in (iii) is limited to a predetermined time period, or to a predetermined number of attempts.

6. Method of claim 2, wherein the method further comprises the step of:
(iv) Repeating step (iii) once each for each different operating system class in a set of different operating system classes until a successful driver installation occurs, wherein the successfully installed driver is operable to enable communication between the host and the device, and terminating the method if the successfully installed driver is successfully installed.

7. Method of claim 6, wherein each attempt in (iv) is limited to a corresponding predetermined time period, or to a predetermined number of attempts.

8. Method of claim 2, wherein the method further comprises the step of:
(iv) Repeating steps (ii) and (iii) for each different operating system class in a set of different operating system classes until a successful driver installation occurs, wherein the successfully installed driver is operable to enable communication between the host and the device, and terminating the method if the successfully installed driver is successfully installed.

9. Method of claim 8, wherein each attempt in (iv) is limited to a corresponding predetermined time period, or to a predetermined number of attempts.

10. Method of claim 1, wherein the method further comprises the step of:
(v) If all attempts at driver installation are unsuccessful, prompting a user to connect a physical medium to the host, to install a driver to communicate between the host and the device.

11. Method of claim 10, wherein the physical medium is a CD-ROM, and connection includes inserting the CD-ROM into a host CD-ROM drive.

12. Method of claim 11, further comprising the step of driver installation by autorun from the CD-ROM.

13. Method of claim 11, further comprising the step of driver installation by manual installation from the CD-ROM.

14. Method of claim 10, wherein the physical medium is a USB-FLASH drive, or hard disk drive, and connection includes connecting the USB-FLASH drive or hard disk drive to the host.

15. Method of claim 1, wherein a physical medium for driver installation is emulated and mounted automatically.

16. Method of claim 1, wherein the method further comprises the step of:
(v) If all attempts at driver installation are unsuccessful, prompting a user to connect the host to a server supplying drivers relating to the host operating system, to install a driver to communicate between the host and the device.

17. Method of claim 16, further comprising the step of: downloading the driver to the host from the server supplying drivers relating to the host operating system, and installing the driver on the host.

18. Method of claim 2, wherein a detected host operating system class is Windows supporting RNDIS, and an operating system class different to the detected host operating system class is Mac/Linux.

19. Method of claim 2, wherein a detected host operating system class is Mac/Linux, and an operating system class different to the detected host operating system class is Windows supporting RNDIS.

20. Method of claim 2, wherein a detected host operating system class is Mac/Linux supporting WWAN, and an operating system class different to the detected host operating system class is Mac/Linux supporting CDC-ECM.

21. Method of claim 6, wherein a detected host operating system class of step (ii) is Mac/Linux supporting WWAN, an operating system class of step (iii) different to the detected host operating system class is Mac/Linux supporting CDC-ECM, and an operating system class of step (iv) is Windows supporting RNDIS.

22. Method of claim 1, further comprising the step of terminating the method if installation of a driver to emulate a network card on the host corresponding to the detected host operating system class is unsuccessful.

23. Method of claim 2, further comprising the step of terminating the method if installation in step (iii) is unsuccessful.

24. Method of claim 2, further comprising the steps of repeating step (ii) and step (iii) if installation in step (iii) is unsuccessful.

25. Method of claim 6, further comprising the step of terminating the method if installation in step (iv) is unsuccessful for each different operating system class.

26. Method of claim 6, further comprising the steps of repeating step (ii), step (iii) and step (iv) if installation in step (iv) is unsuccessful.

27. Method of claim 6, wherein the set of different operating system classes contains at least three different operating system classes.

28. Method of claim 1, wherein the driver to emulate a network card for communicating between the host and the device is for wireless communication between the host and the device.

29. A system comprising:
a host; and
a device for:
detecting a host operating system class from the device side by USB enumeration;
attempting to install a first driver to emulate a network card on the host corresponding to the detected host operating system class, wherein the installed first driver is operable to enable communication between the host and the device; and
terminating the install attempt if the first driver is successfully installed.

30. System of claim 29, wherein the device is a mobile communications device.

31. System of claim 30, wherein the mobile communications device is operable to provide instant and automatic sharing of a wireless network in response to a single action by a user, the single action comprising a physical contact gesture with the mobile device by the user, or a voice activation command by the user.

32. System of claim 29, where the device is a portable router device including a wide area network interface and a local area network interface, the portable router device operable to connect to a wide area network using the wide area network interface, the portable router device further operable to provide a local area network using the local area network interface in response to the device connection with the wide area network satisfying a connection condition.

33. System of claim 29, wherein the device is a wireless data enabled USB dongle operable to receive streamed files.

34. System of claim 29, wherein the device is a wireless data enabled USB dongle operable to provide internet access.

35. System of claim 29, wherein the device is a bar form factor display device comprising front and back major faces, the front major face arranged to present a first display screen and the back major face arranged to present a second display screen different to the first display screen.

36. System of claim 29, wherein the device is a display device assembly including a bar form factor display device and a detachable casing, the assembly operable to be assembled wherein the detachable casing is in attachment with the bar form factor display device, the assembly when assembled comprising front and back major faces, wherein the front major face is arranged to present a first display screen which forms part of the bar form factor display device, and wherein the back major face is arranged to present a second display screen different to the first display screen, which forms part of the detachable casing.

37. Computer program product operable when installed on a USB device to perform a method of installing a driver to emulate a network card for communicating between a host and the device, wherein a host operating system class of the host is detected from the device side, comprising the steps of:
(i) detecting the host operating system class from the device side by USB enumeration;
(ii) attempting to install a first driver to emulate a network card on the host corresponding to the detected host operating system class, wherein the installed first driver is operable to enable communication between the host and the device, and terminating the method if the first driver is successfully installed.

38. Computer program product of claim 37, further operable to perform the method step of:
(iii) If the first driver installation in (ii) is unsuccessful, attempting to install a second driver to emulate a network card on the host corresponding to an operating system class different to the detected host operating system class, wherein the installed second driver is operable to enable communication between the host and the device, and terminating the method if the second driver is successfully installed.

39. (canceled)
